(19) United States
(12) Patent Application Publication
(10) Pub. No.: US 2016/0055781 A1
(43) Pub. Date: Feb. 25, 2016

(54) IMAGE DEVICE WITH IMRPOVED CHROMINANCE QUALITY

(71) Applicant: VP ASSETS LIMITED, Tortola (VG)

(72) Inventors: Gia Chuong Phan, West Kowloon (HK); Maggie Phan, West Kowloon (HK); Anthony Phan, West Kowloon (HK)

(21) Appl. No.: 14/465,496

(22) Filed: Aug. 21, 2014

(51) Int. Cl. G09G 3/20; G09G 3/32

(52) U.S. Cl. CPC G09G 3/2003; G09G 3/3208; G09G 2320/0242; G09G 2300/0452

(57) ABSTRACT

The invention provides an image device and a method for determining the ratio of the number of RGBW pixels to the number of RGBY pixels. The image device includes a plurality of RGBW pixels and a plurality of RGBY pixels. Each RGBW pixel includes a red sub-pixel, a green sub-pixel, a blue sub-pixel and a white sub-pixel. Each RGBY pixel includes a red sub-pixel, a green sub-pixel, a blue sub-pixel and a yellow sub-pixel. Four sub-pixels arranged in a 2×2 matrix are formed the RGBW pixel or the RGBY pixel, the RGBW pixels and the RGBY pixels are mixed in the image device. The image device and the method of the present invention can solve the problem of dark yellow in the conventional RGBW display, and improve chrominance quality.

### BACKGROUND OF THE INVENTION

1. Field of the Invention

The invention relates to an image device and a method for determining the ratio of the number of RGBW pixels to the number of RGBY pixels.

2. Description of the Related Art

Referring to FIG. 1, it shows a conventional RGBW display. The conventional RGBW display 10 includes a plurality of RGBW pixels 11. Each RGBW pixel 11 includes a green sub-pixel 111, a red sub-pixel 112, a blue sub-pixel 113 and a white sub-pixel 114 arranged in a 2×2 matrix. The conventional RGBW display 10 has the merit of enhanced color space and improved brightness and contrast, compared with traditional RGB display. U.S. Pat. No. 4,892,391, U.S. Pat. No. 5,757,452, U.S. Pat. Nos. 7,286,136, 7,742,205, and U.S. Pat. No. 7,583,279 teach RGBW displays. However, the conventional RGBW display 10 has the deficiency of dark yellow. U.S. Pat. No. 4,800,375, U.S. Pat. No. 7,864,271, and U.S. Pat. No. 8,749,727 teach RGBY displays which claim to have better yellow color. However, RGBY display lacks the merits of RGBW displays. U.S. Pat. No. 7,248,314, U.S. Pat. No. 7,995,019, U.S. Pat. No. 8,248,440, U.S. Pat. No. 8,441,601 and U.S. Pat. No. 8,558,857 teach displays with five color sub-pixels. However five color displays have the deficiency of high cost and low brightness and contrast.

### SUMMARY OF THE INVENTION

The present invention provides an image device. The image device includes a plurality of RGBW pixels and a plurality of RGBY pixels. Each RGBW pixel includes a red sub-pixel, a green sub-pixel, a blue sub-pixel and a white sub-pixel. Each RGBY pixel includes a red sub-pixel, a green sub-pixel, a blue sub-pixel and a yellow sub-pixel. Four sub-pixels arranged in a 2×2 matrix are formed the RGBW pixel or the RGBY pixel, the RGBW pixels and the RGBY pixels are mixed in the image device.

The present invention also provides a method to determine the ratio of the number of RGBW pixels to the number of RGBY pixels in an image device. The method includes a step for determining the ratio by a function of a yellow sub-pixel information, a red sub-pixel information, a green sub-pixel information, a blue sub-pixel information and a white sub-pixel information of the image device.

The present invention also provides a method to determine the ratio of the number of RGBW pixels to the number of RGBY pixels in an image device. The method includes a step for determining the ratio by a function of a yellow sub-pixel information and a white sub-pixel information of the image device.

The image device and the method of the present invention can solve the problem of dark yellow in the conventional RGBW display, and improve chrominance quality.

### BRIEF DESCRIPTION OF THE DRAWING

Further advantageous measures are described in the dependent claims. The invention is shown in the attached drawing and is described hereinafter in greater detail.

FIG. 1 shows a conventional RGBW display;

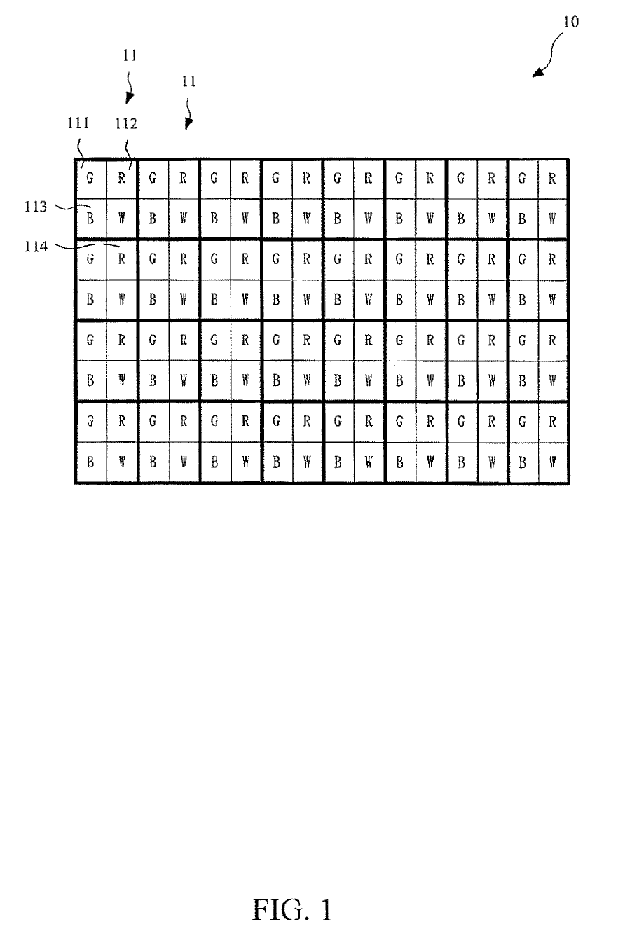

FIG. 2A shows an image device according to an embodiment of the invention;

FIG. 2B shows an image device according to an embodiment of the invention;

FIG. 2C shows an image device according to an embodiment of the invention;

FIG. 2D shows an image device according to an embodiment of the invention;

FIG. 2E shows an image device according to an embodiment of the invention;

FIG. 2F shows an image device according to an embodiment of the invention;

FIG. 3 shows an image device according to an embodiment of the invention;

FIG. 4 shows an image device according to an embodiment of the invention;

FIG. 5A shows an image device according to an embodiment of the invention;

FIG. 5B shows an image device according to an embodiment of the invention;

FIG. 5C shows an image device according to an embodiment of the invention;

FIG. 5D shows an image device according to an embodiment of the invention;

FIG. 5E shows an image device according to an embodiment of the invention;

FIG. 6 shows an image device according to an embodiment of the invention;

FIG. 7 shows an image device according to an embodiment of the invention;

FIG. 8 shows an image device according to an embodiment of the invention;

FIG. 9 shows an image device according to an embodiment of the invention;

FIG. 10 shows an image device according to an embodiment of the invention;

FIG. 11 shows an image device according to an embodiment of the invention;

FIG. 12 shows an image device according to an embodiment of the invention;

FIG. 13 shows an image device according to an embodiment of the invention;

FIG. 14 shows an image device according to an embodiment of the invention;

FIG. 15 shows an image device according to an embodiment of the invention;

FIG. 16 shows an image device according to an embodiment of the invention;

FIG. 17 shows an image device according to an embodiment of the invention;

FIG. 18 shows an image device according to an embodiment of the invention;

FIG. 19 shows an image device according to an embodiment of the invention;

FIG. 20 shows an image device according to an embodiment of the invention;

FIG. 21 shows an image device according to an embodiment of the invention;

FIG. 22 shows an image device according to an embodiment of the invention;

FIG. 23 shows an image device according to an embodiment of the invention;

FIG. 24 shows an image device according to an embodiment of the invention;

FIG. 25 shows an image device according to an embodiment of the invention;

FIG. 26 shows an image device according to an embodiment of the invention; and

FIG. 27 shows an image device according to an embodiment of the invention.

### DETAILED DESCRIPTION OF THE INVENTION

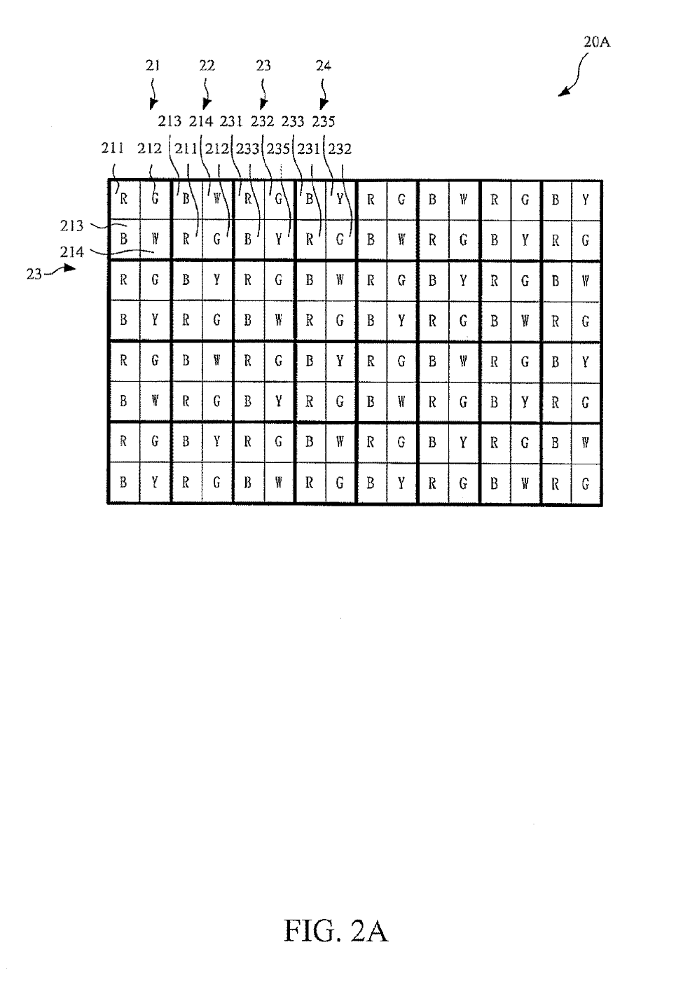

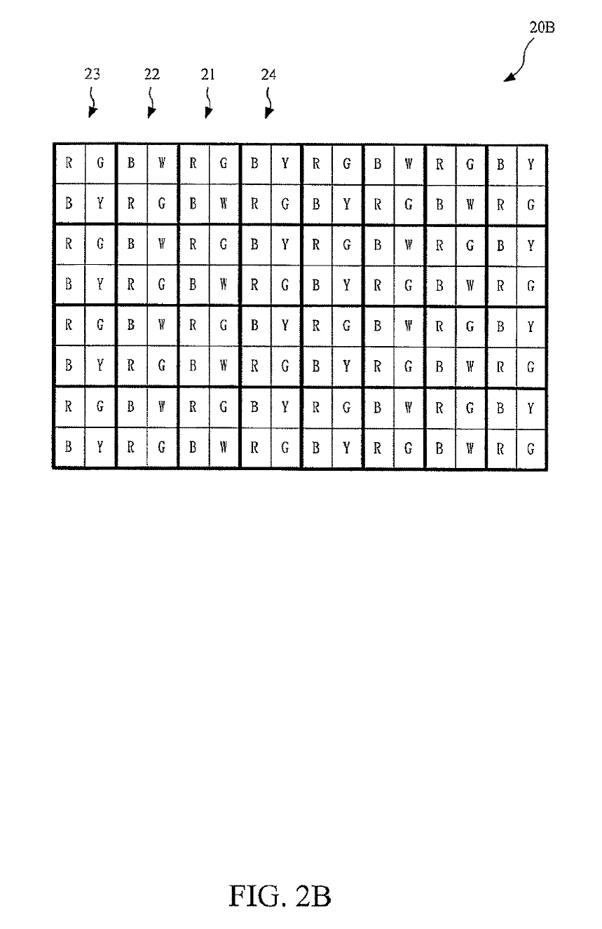

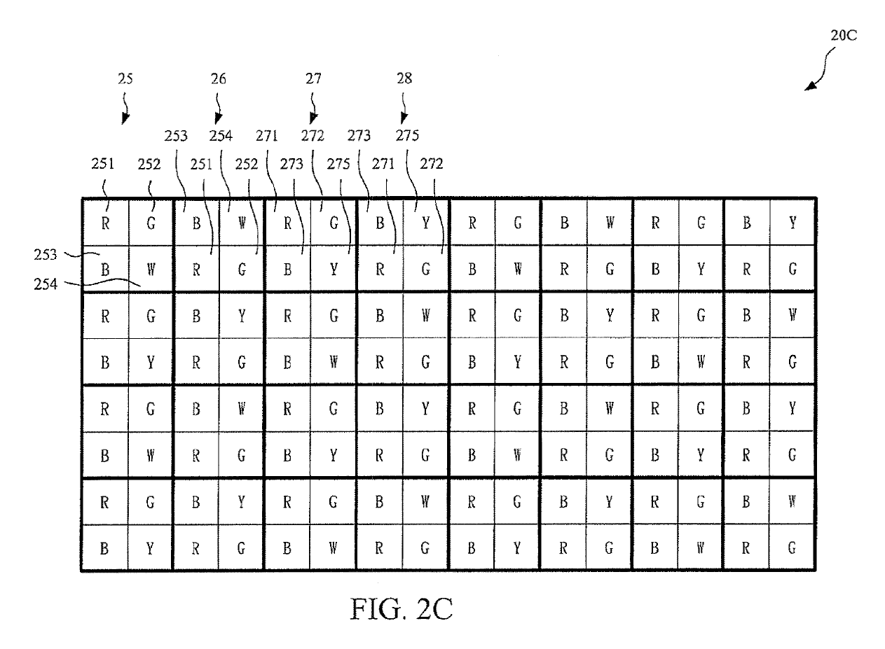

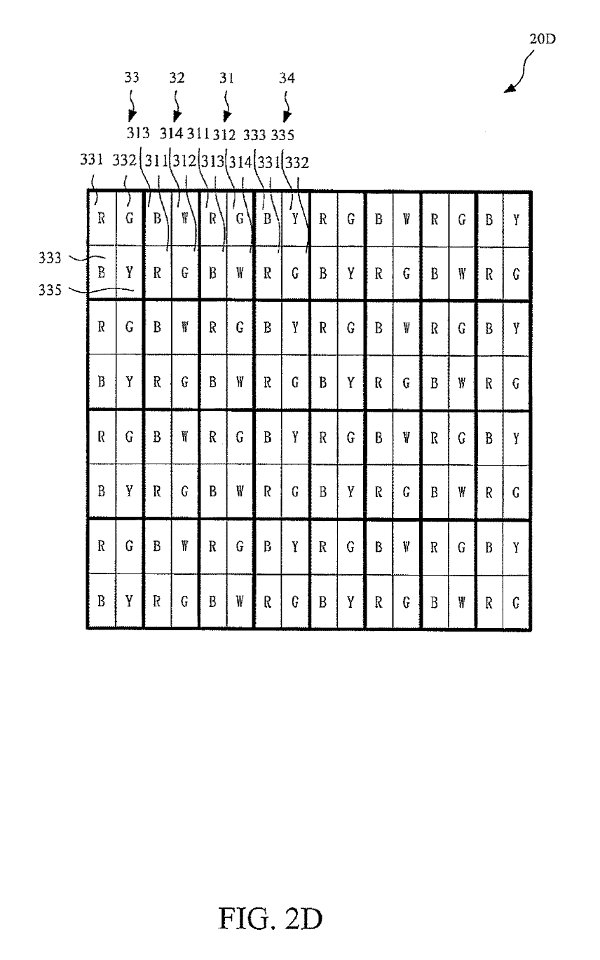

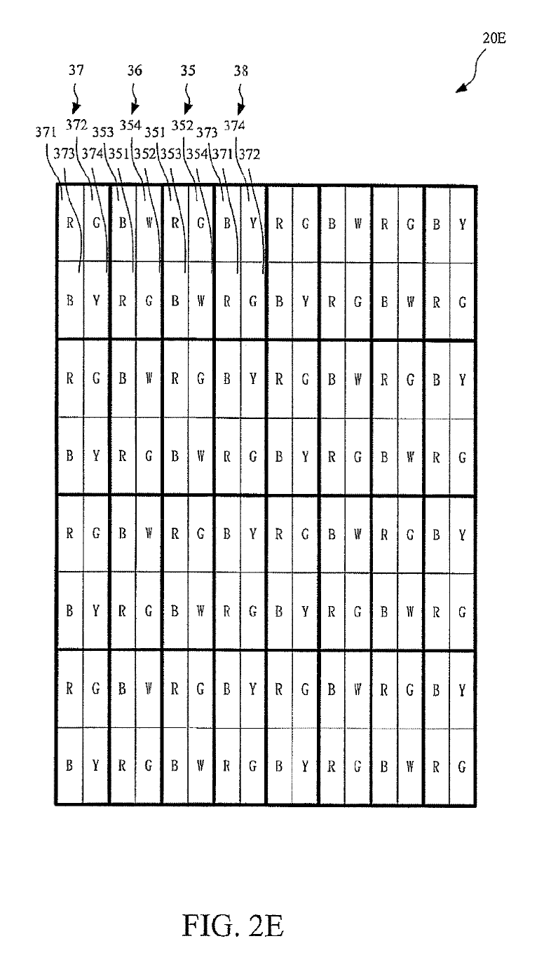

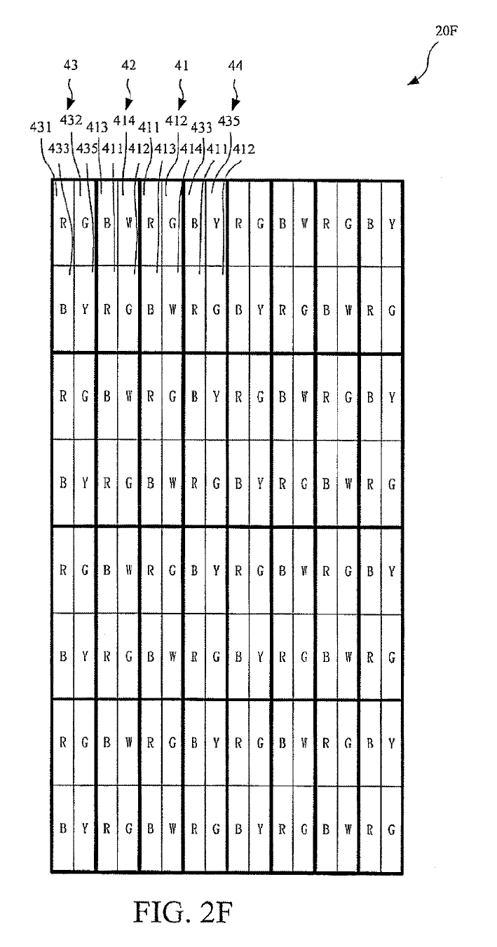

Referring to FIG. 2A, it shows an image device according to an embodiment of the invention. The image device 20A includes a plurality of RGBW pixels 21, 22, and a plurality of RGBY pixels 23, 24. Each RGBW pixel includes a red sub-pixel, a green sub-pixel, a blue sub-pixel and a white sub-pixel. The RGBW pixel 21 includes a red sub-pixel 211, a green sub-pixel 212, a blue sub-pixel 213 and a white sub-pixel 214, and the RGBW pixel 22 includes a red sub-pixel 211, a green sub-pixel 212, a blue sub-pixel 213 and a white sub-pixel 214. In an embodiment, the red sub-pixel 211, the green sub-pixel 212, the blue sub-pixel 213 and the white sub-pixel 214 are arranged in a 2×2 matrix. Each sub-pixel is formed as about a rectangular shape.

In the RGBW pixel 21, the red sub-pixel 211 is disposed on a first column and first row position of the RGBW pixel 21, the green sub-pixel 212 is disposed on a second column and first row position of the RGBW pixel 21, the blue sub-pixel 213 is disposed on a first column and second row position of the RGBW pixel 21, and the white sub-pixel 214 is disposed on a second column and second row position of the RGBW pixel 21. In the RGBW pixel 22, the blue sub-pixel 213 is disposed on a first column and first row position of the RGBW pixel 22, the white sub-pixel 214 is disposed on a second column and first row position of the RGBW pixel 22, the red sub-pixel 211 is disposed on a first column and second row position of the RGBW pixel 22, and the green sub-pixel 212 is disposed on a second column and second row position of the RGBW pixel 22.

Each RGBY pixel includes a red sub-pixel, a green sub-pixel, a blue sub-pixel and a yellow sub-pixel. The RGBY pixel 23 includes a red sub-pixel 231, a green sub-pixel 232, a blue sub-pixel 233 and a yellow sub-pixel 235, and the RGBY pixel 24 includes a red sub-pixel 231, a green sub-pixel 232, a blue sub-pixel 233 and a yellow sub-pixel 235. In an embodiment, the red sub-pixel 231, the green sub-pixel 232, the blue sub-pixel 233 and the yellow sub-pixel 235 are arranged in a 2×2 matrix. Each sub-pixel is formed as about a rectangular shape.

In the RGBY pixel 23, the red sub-pixel 231 is disposed on a first column and first row position of the RGBY pixel 23, the green sub-pixel 232 is disposed on a second column and first row position of the RGBY pixel 23, the blue sub-pixel 233 is disposed on a first column and second row position of the RGBY pixel 23, and the yellow sub-pixel 235 is disposed on a second column and second row position of the RGBY pixel 23. In the RGBY pixel 24, the blue sub-pixel 233 is disposed on a first column and first row position of the RGBY pixel 24, the yellow sub-pixel 235 is disposed on a second column and first row position of the RGBY pixel 24, the red sub-pixel 231 is disposed on a first column and second row position of the RGBY pixel 24, and the green sub-pixel 232 is disposed on a second column and second row position of the RGBY pixel 24.

Given the above, four sub-pixels arranged in a 2×2 matrix are formed the RGBW pixel 21 or 22 or the RGBY pixel 23 or 24. The RGBW pixels 21, 22 and the RGBY pixels 23, 24 are mixed in the image device 20A. The RGBY pixels 23, 24 are added to the image device 20A to solve the problem of dark yellow, and improve chrominance quality. The ratio of the number of RGBW pixels to the number of RGBY pixels is determined by a function of the yellow sub-pixel information, the red and green sub-pixels information, and the color space information of the image device. In an embodiment, the number of RGBW pixels is greater than or equal to the number of RGBY pixels. In the image device 20A, the ratio of the number of RGBW pixels to the number of RGBY pixels is about 1:1.

Further, the red sub-pixel 211 and the green sub-pixel 212 in the RGBW pixel 21, the blue sub-pixel 213 and the white sub-pixel 214 in the RGBW pixel 22 are arranged in a row of the image device 20A, and the above four sub-pixels are formed the RGBW pixel. The red sub-pixel 231 and the green sub-pixel 232 in the RGBY pixel 23, the blue sub-pixel 233 and the yellow sub-pixel 235 in the RGBY pixel 24 are arranged in a row of the image device 20A, and the above four sub-pixels are formed the RGBY pixel.

Furthermore, the image device includes at least one block. The block includes nine sub-pixels arranged in a 3×3 matrix, a white sub-pixel or a yellow sub-pixel is disposed in a center of the 3×3 matrix, and the other sub-pixels includes two red sub-pixels, three green sub-pixels and three blue sub-pixels; or two green sub-pixels, three red sub-pixels and three blue sub-pixels; or two blue sub-pixels, three green sub-pixels and three red sub-pixels.

Referring to FIG. 2B, it shows an image device according to an embodiment of the invention. The image device 20B includes a plurality of RGBW pixels 21, 22, and a plurality of RGBY pixels 23, 24. The ratio of the number of RGBW pixels to the number of RGBY pixels is about 1:1.

Referring to FIG. 2C, it shows an image device according to an embodiment of the invention. The image device 20C includes a plurality of RGBW pixels 25, 26, and a plurality of RGBY pixels 27, 28. The RGBW pixel 25 includes a red sub-pixel 251, a green sub-pixel 252, a blue sub-pixel 253 and a white sub-pixel 254, and the RGBW pixel 26 includes a red sub-pixel 251, a green sub-pixel 252, a blue sub-pixel 253 and a white sub-pixel 254. In an embodiment, the red sub-pixel 251, the green sub-pixel 252, the blue sub-pixel 253 and the white sub-pixel 254 are arranged in a 2×2 matrix. Each sub-pixel is formed as about a square shape.

The RGBY pixel 27 includes a red sub-pixel 271, a green sub-pixel 272, a blue sub-pixel 273 and a yellow sub-pixel 275, and the RGBY pixel 28 includes a red sub-pixel 271, a green sub-pixel 272, a blue sub-pixel 273 and a yellow sub-pixel 275. Each sub-pixel is formed as about a square shape. The ratio of the number of RGBW pixels to the number of RGBY pixels is about 1:1.

Referring to FIG. 2D, it shows an image device according to an embodiment of the invention. The image device 20D includes a plurality of RGBW pixels 31, 32, and a plurality of RGBY pixels 33, 34. The RGBW pixel 31 includes a red sub-pixel 311, a green sub-pixel 312, a blue sub-pixel 313 and a white sub-pixel 314, and the RGBW pixel 32 includes a red sub-pixel 311, a green sub-pixel 312, a blue sub-pixel 313 and a white sub-pixel 314. In an embodiment, the red sub-pixel 311, the green sub-pixel 312, the blue sub-pixel 313 and the white sub-pixel 314 are arranged in a 2×2 matrix. Any two adjacent sub-pixels along a longer border are formed as about a square shape. That is, two adjacent sub-pixels, for example the red sub-pixel 311 and the green sub-pixel 312, along a longer border are formed as about a square shape.

The RGBY pixel 33 includes a red sub-pixel 331, a green sub-pixel 332, a blue sub-pixel 333 and a yellow sub-pixel 335, and the RGBY pixel 34 includes a red sub-pixel 331, a green sub-pixel 332, a blue sub-pixel 333 and a yellow sub-pixel 335. Any two adjacent sub-pixels along a longer border are formed as about a square shape. That is, two adjacent sub-pixels, for example the blue sub-pixel 333 and the yellow sub-pixel 335, along a longer border are formed as about a square shape. The ratio of the number of RGBW pixels to the number of RGBY pixels is about 1:1.

Referring to FIG. 2E, it shows an image device according to an embodiment of the invention. The image device 20E includes a plurality of RGBW pixels 35, 36, and a plurality of RGBY pixels 37, 38. The RGBW pixel 35 includes a red sub-pixel 351, a green sub-pixel 352, a blue sub-pixel 353 and a white sub-pixel 354, and the RGBW pixel 36 includes a red sub-pixel 351, a green sub-pixel 352, a blue sub-pixel 353 and a white sub-pixel 354. In an embodiment, the red sub-pixel 351, the green sub-pixel 352, the blue sub-pixel 353 and the white sub-pixel 354 are arranged in a 2×2 matrix. Any three adjacent sub-pixels along a longer border are formed as about a square shape. That is, three adjacent sub-pixels, for example the red sub-pixel 351 and the green sub-pixel 352 in the RGBW pixel 35 and the white sub-pixel 354 in the RGBW pixel 36, along a longer border are formed as about a square shape.

The RGBY pixel 37 includes a red sub-pixel 371, a green sub-pixel 372, a blue sub-pixel 373 and a yellow sub-pixel 375, and the RGBY pixel 38 includes a red sub-pixel 371, a green sub-pixel 372, a blue sub-pixel 373 and a yellow sub-pixel 375. Any three adjacent sub-pixels along a longer border are formed as about a square shape. That is, three adjacent sub-pixels, for example the red sub-pixel 371 and the green sub-pixel 372 in the RGBY pixel 37 and the blue sub-pixel 353 in the RGBW pixel 36, along a longer border are formed as about a square shape. The ratio of the number of RGBW pixels to the number of RGBY pixels is about 1:1.

Referring to FIG. 2F, it shows an image device according to an embodiment of the invention. The image device 20F includes a plurality of RGBW pixels 41, 42, and a plurality of RGBY pixels 43, 44. The RGBW pixel 41 includes a red sub-pixel 411, a green sub-pixel 412, a blue sub-pixel 413 and a white sub-pixel 414, and the RGBW pixel 42 includes a red sub-pixel 411, a green sub-pixel 412, a blue sub-pixel 413 and a white sub-pixel 414. In an embodiment, the red sub-pixel 411, the green sub-pixel 412, the blue sub-pixel 413 and the white sub-pixel 414 are arranged in a 2×2 matrix. Any four adjacent sub-pixels along a longer border are formed as about a square shape. That is, four adjacent sub-pixels, for example the red sub-pixel 411 and the green sub-pixel 422 in the RGBW pixel 41 and the blue sub-pixel 413 and the white sub-pixel 414 in the RGBW pixel 42, along a longer border are formed as about a square shape.

The RGBY pixel 43 includes a red sub-pixel 431, a green sub-pixel 432, a blue sub-pixel 433 and a yellow sub-pixel 435, and the RGBY pixel 44 includes a red sub-pixel 431, a green sub-pixel 432, a blue sub-pixel 433 and a yellow sub-pixel 435. Any four adjacent sub-pixels along a longer border are formed as about a square shape. That is, four adjacent sub-pixels, for example the red sub-pixel 431 and the green sub-pixel 432 in the RGBY pixel 43 and the blue sub-pixel 413 and the white sub-pixel 414 in the RGBW pixel 42, along a longer border are formed as about a square shape. The ratio of the number of RGBW pixels to the number of RGBY pixels is about 1:1.

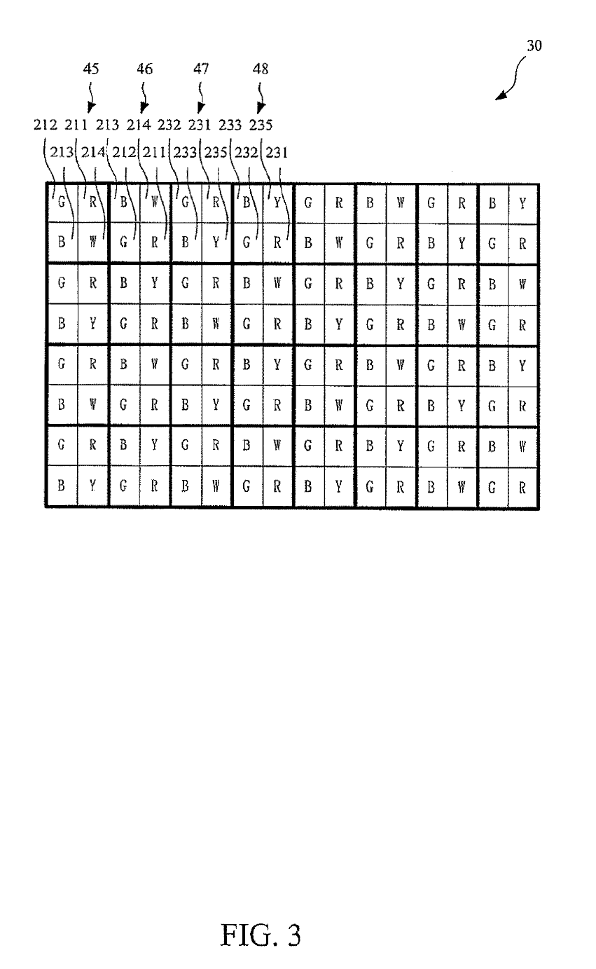

Referring to FIG. 3, it shows an image device according to an embodiment of the invention. The image device 30 includes a plurality of RGBW pixels 45, 46, and a plurality of RGBY pixels 47, 48. The RGBW pixel 45 includes a red sub-pixel 211, a green sub-pixel 212, a blue sub-pixel 213 and a white sub-pixel 214, and the RGBW pixel 46 includes a red sub-pixel 211, a green sub-pixel 212, a blue sub-pixel 213 and a white sub-pixel 214. In an embodiment, the red sub-pixel 211, the green sub-pixel 212, the blue sub-pixel 213 and the white sub-pixel 214 are arranged in a 2×2 matrix.

In the RGBW pixel 45, the green sub-pixel 212 is disposed on a first column and first row position of the RGBW pixel 45, the red sub-pixel 211 is disposed on a second column and first row position of the RGBW pixel 45, the blue sub-pixel 213 is disposed on a first column and second row position of the RGBW pixel 45, and the white sub-pixel 214 is disposed on a second column and second row position of the RGBW pixel 45. In the RGBW pixel 46, the blue sub-pixel 213 is disposed on a first column and first row position of the RGBW pixel 46, the white sub-pixel 214 is disposed on a second column and first row position of the RGBW pixel 46, the green sub-pixel 212 is disposed on a first column and second row position of the RGBW pixel 46, and the red sub-pixel 211 is disposed on a second column and second row position of the RGBW pixel 46.

The RGBY pixel 47 includes a red sub-pixel 231, a green sub-pixel 232, a blue sub-pixel 233 and a yellow sub-pixel 235, and the RGBY pixel 48 includes a red sub-pixel 231, a green sub-pixel 232, a blue sub-pixel 233 and a yellow sub-pixel 235. In an embodiment, the red sub-pixel 231, the green sub-pixel 232, the blue sub-pixel 233 and the yellow sub-pixel 235 are arranged in a 2×2 matrix.

In the RGBY pixel 47, the green sub-pixel 232 is disposed on a first column and first row position of the RGBY pixel 47, the red sub-pixel 231 is disposed on a second column and first row position of the RGBY pixel 47, the blue sub-pixel 233 is disposed on a first column and second row position of the RGBY pixel 47, and the yellow sub-pixel 235 is disposed on a second column and second row position of the RGBY pixel 47. In the RGBY pixel 48, the blue sub-pixel 233 is disposed on a first column and first row position of the RGBY pixel 48, the yellow sub-pixel 235 is disposed on a second column and first row position of the RGBY pixel 48, the green sub-pixel 232 is disposed on a first column and second row position of the RGBY pixel 48, and the red sub-pixel 231 is disposed on a second column and second row position of the RGBY pixel 48. In the image device 30, the ratio of the number of RGBW pixels to the number of RGBY pixels is about 1:1.

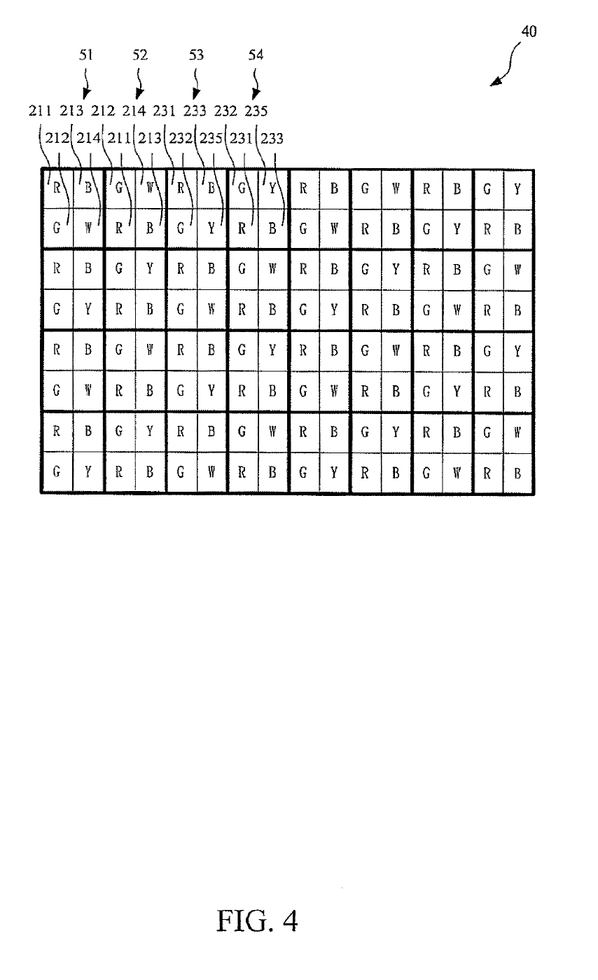

Referring to FIG. 4, it shows an image device according to an embodiment of the invention. The image device 40 includes a plurality of RGBW pixels 51, 52, and a plurality of RGBY pixels 53, 54. The RGBW pixel 51 includes a red sub-pixel 211, a green sub-pixel 212, a blue sub-pixel 213 and a white sub-pixel 214, and the RGBW pixel 52 includes a red sub-pixel 211, a green sub-pixel 212, a blue sub-pixel 213 and a white sub-pixel 214. In an embodiment, the red sub-pixel 211, the green sub-pixel 212, the blue sub-pixel 213 and the white sub-pixel 214 are arranged in a 2×2 matrix.

In the RGBW pixel 51, the red sub-pixel 211 is disposed on a first column and first row position of the RGBW pixel 51, the blue sub-pixel 213 is disposed on a second column and first row position of the RGBW pixel 51, the green sub-pixel 212 is disposed on a first column and second row position of the RGBW pixel 51, and the white sub-pixel 214 is disposed on a second column and second row position of the RGBW pixel 51. In the RGBW pixel 52, the green sub-pixel 212 is disposed on a first column and first row position of the RGBW pixel 52, the white sub-pixel 214 is disposed on a second column and first row position of the RGBW pixel 52, the red sub-pixel 211 is disposed on a first column and second row position of the RGBW pixel 52, and the blue sub-pixel 213 is disposed on a second column and second row position of the RGBW pixel 52.

Each RGBY pixel includes a red sub-pixel, a green sub-pixel, a blue sub-pixel and a yellow sub-pixel. The RGBY pixel 53 includes a red sub-pixel 231, a green sub-pixel 232, a blue sub-pixel 233 and a yellow sub-pixel 235, and the RGBY pixel 54 includes a red sub-pixel 231, a green sub-pixel 232, a blue sub-pixel 233 and a yellow sub-pixel 235. In an embodiment, the red sub-pixel 231, the green sub-pixel 232, the blue sub-pixel 233 and the yellow sub-pixel 235 are arranged in a 2×2 matrix.

In the RGBY pixel 53, the red sub-pixel 231 is disposed on a first column and first row position of the RGBY pixel 53, the blue sub-pixel 233 is disposed on a second column and first row position of the RGBY pixel 53, the green sub-pixel 232 is disposed on a first column and second row position of the RGBY pixel 53, and the yellow sub-pixel 235 is disposed on a second column and second row position of the RGBY pixel 53. In the RGBY pixel 54, the green sub-pixel 232 is disposed on a first column and first row position of the RGBY pixel 54, the yellow sub-pixel 235 is disposed on a second column and first row position of the RGBY pixel 54, the red sub-pixel 231 is disposed on a first column and second row position of the RGBY pixel 54, and the blue sub-pixel 233 is disposed on a second column and second row position of the RGBY pixel 54. In the image device 40, the ratio of the number of RGBW pixels to the number of RGBY pixels is about 1:1.

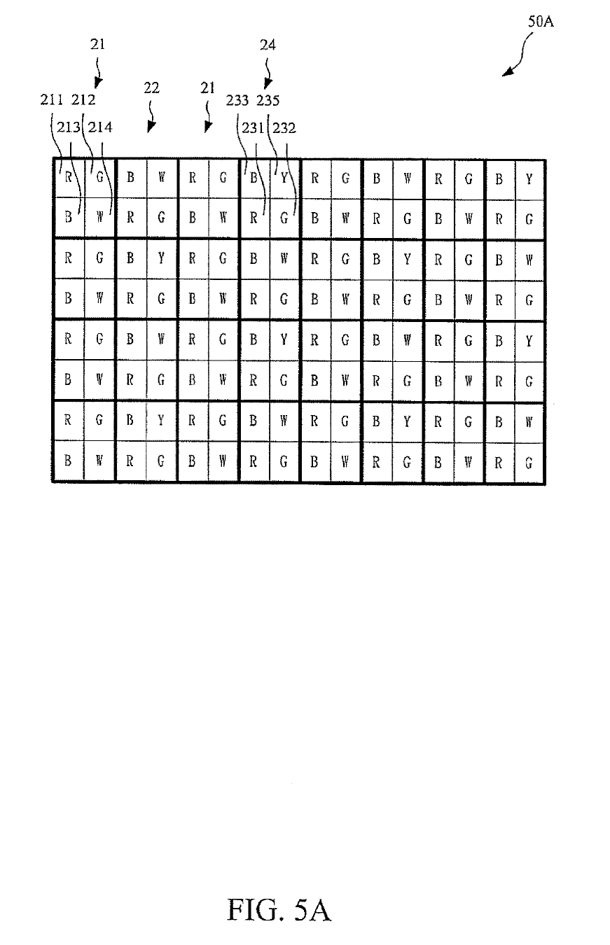

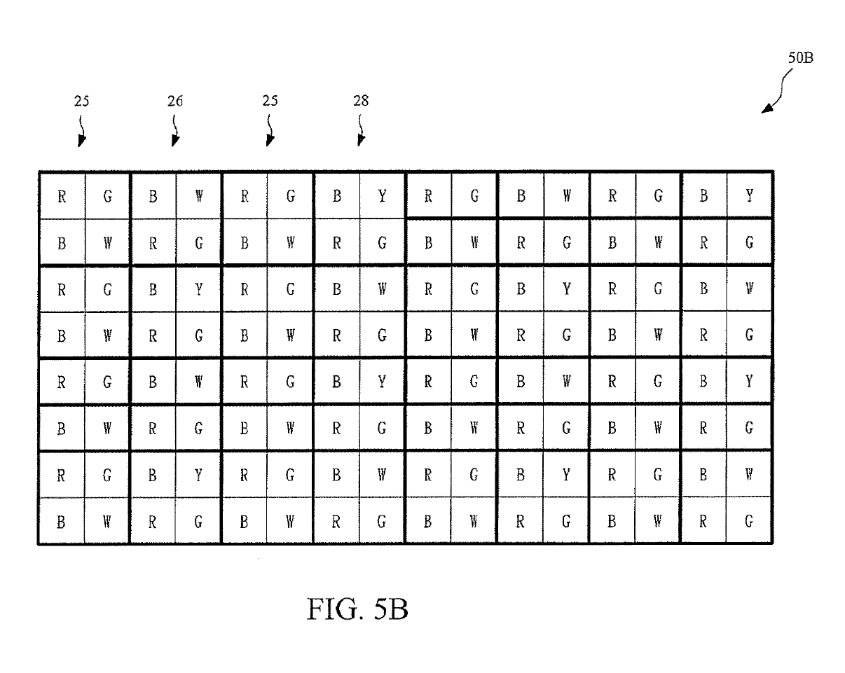

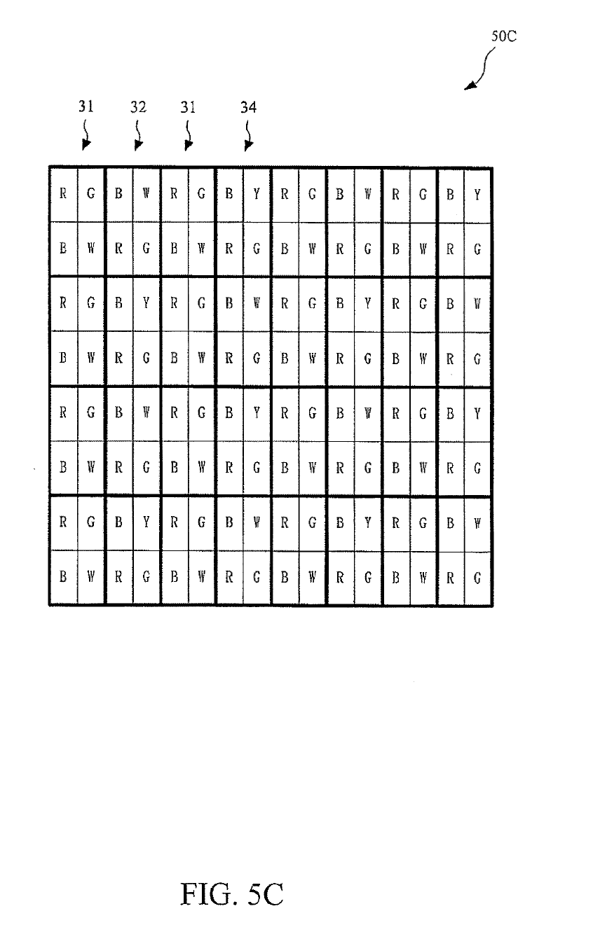

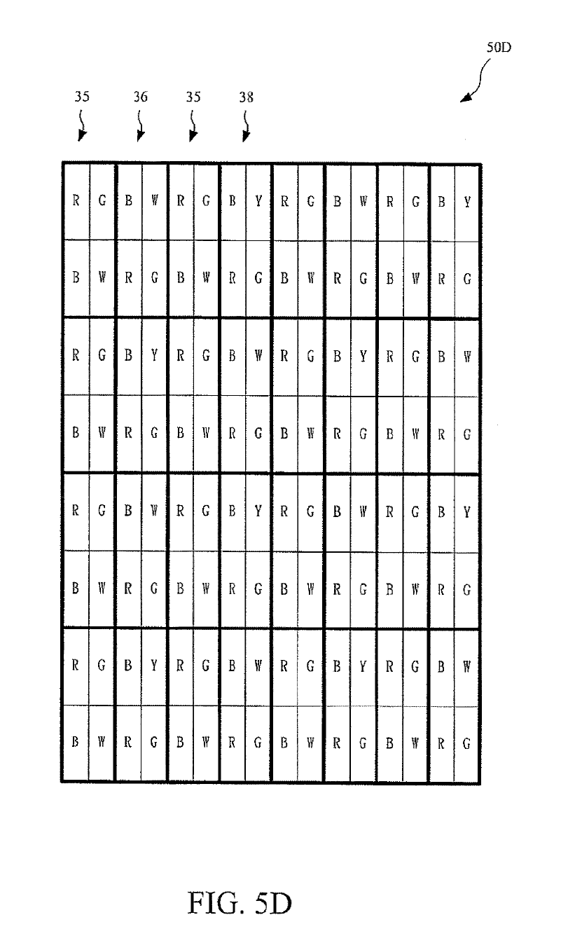

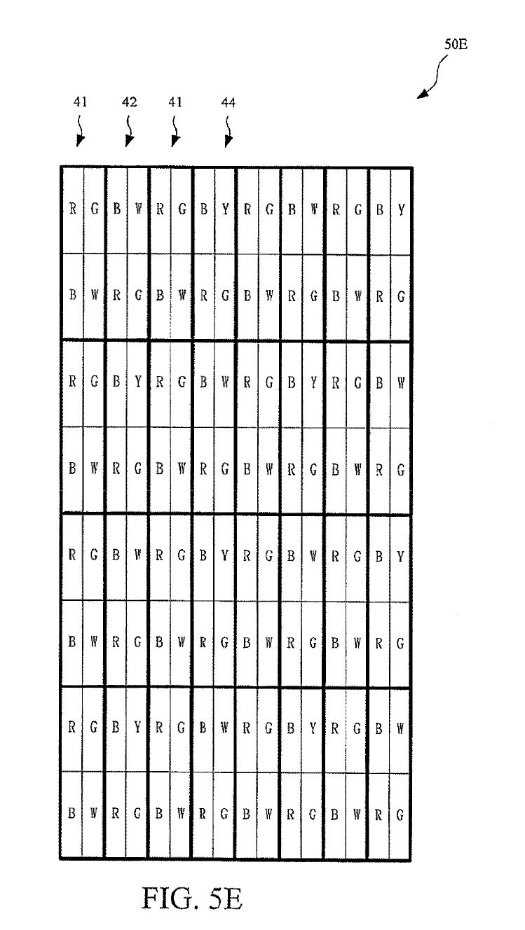

Referring to FIG. 5A, it shows an image device according to an embodiment of the invention. The image device 50A includes a plurality of RGBW pixels 21, 22, and a plurality of RGBY pixels 24. In the image device 50A, the ratio of the number of RGBW pixels to the number of RGBY pixels is about 3:1.

Referring to FIG. 5B, it shows an image device according to an embodiment of the invention. The image device 50B includes a plurality of RGBW pixels 25, 26, and a plurality of RGBY pixels 28. The arrangement in the RGBW pixels 25, 26 and the RGBY pixel 28 of the image device 50B is the same as that of the image device 20C shown in FIG. 2C. Each sub-pixel is formed as about a square shape. In the image device 50B, the ratio of the number of RGBW pixels to the number of RGBY pixels is about 3:1.

Referring to FIG. 5C, it shows an image device according to an embodiment of the invention. The image device 50C includes a plurality of RGBW pixels 31, 32, and a plurality of RGBY pixels 34. The arrangement in the RGBW pixels 31, 32 and the RGBY pixel 34 of the image device 50C is the same as that of the image device 20D shown in FIG. 2D. Any two adjacent sub-pixels along a longer border are formed as about a square shape. That is, two adjacent sub-pixels, for example the red sub-pixel 311 and the green sub-pixel 312 in the RGBW pixel 31, along a longer border are formed as about a square shape. In the image device 50C, the ratio of the number of RGBW pixels to the number of RGBY pixels is about 3:1.

Referring to FIG. 5D, it shows an image device according to an embodiment of the invention. The image device 50D includes a plurality of RGBW pixels 35, 36, and a plurality of RGBY pixels 38. The arrangement in the RGBW pixels 35, 36 and the RGBY pixel 38 of the image device 50D is the same as that of the image device 20E shown in FIG. 2E. Any three adjacent sub-pixels along a longer border are formed as about a square shape. That is, three adjacent sub-pixels, for example the red sub-pixel 351 and the green sub-pixel 352 in the RGBW pixel 35 and the white sub-pixel 354 in the RGBW pixel 36, along a longer border are formed as about a square shape. In the image device 50D, the ratio of the number of RGBW pixels to the number of RGBY pixels is about 3:1.

Referring to FIG. 5E, it shows an image device according to an embodiment of the invention. The image device 50E includes a plurality of RGBW pixels 41, 42, and a plurality of RGBY pixels 44. The arrangement in the RGBW pixels 41, 42 and the RGBY pixel 44 of the image device 50E is the same as that of the image device 20F shown in FIG. 2F. Any four adjacent sub-pixels along a longer border are formed as about a square shape. That is, four adjacent sub-pixels, for example the red sub-pixel 411 and the green sub-pixel 422 in the RGBW pixel 41 and the blue sub-pixel 413 and the white sub-pixel 414 in the RGBW pixel 42, along a longer border are formed as about a square shape. In the image device 50E, the ratio of the number of RGBW pixels to the number of RGBY pixels is about 3:1.

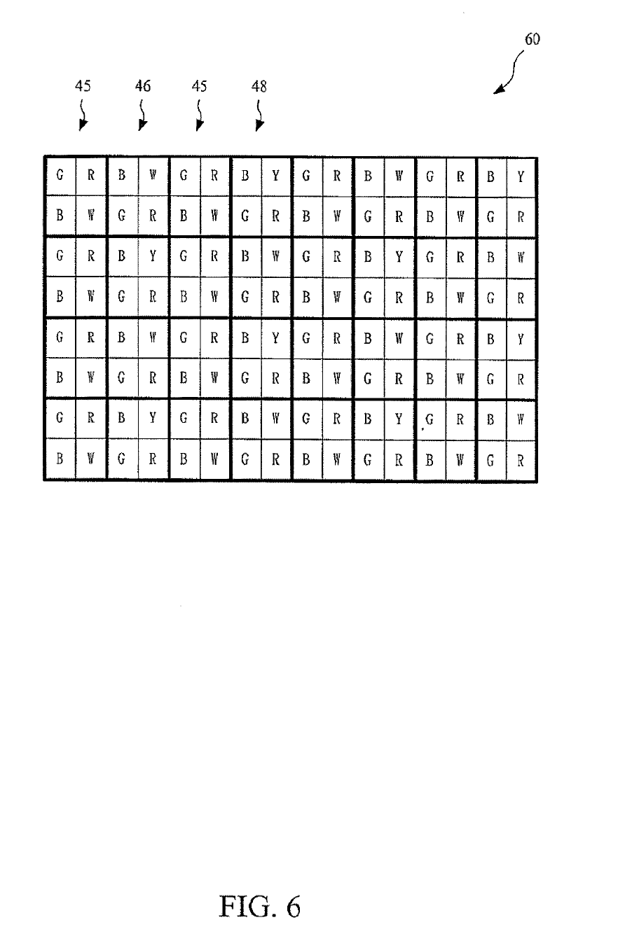

Referring to FIG. 6, it shows an image device according to an embodiment of the invention. The image device 60 includes a plurality of RGBW pixels 45, 46, and a plurality of RGBY pixels 48. The arrangement in the RGBW pixels 45, 46 and the RGBY pixel 48 of the image device 60 is the same as that of the image device 30 shown in FIG. 3. In the image device 60, the ratio of the number of RGBW pixels to the number of RGBY pixels is about 3:1.

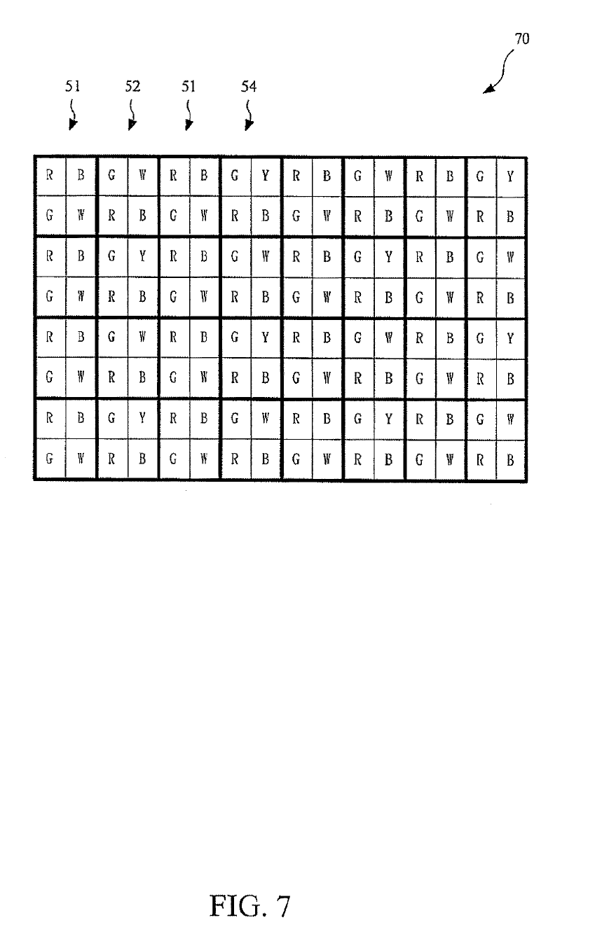

Referring to FIG. 7, it shows an image device according to an embodiment of the invention. The image device 70 includes a plurality of RGBW pixels 51, 52, and a plurality of RGBY pixels 54. The arrangement in the RGBW pixels 51, 52 and the RGBY pixel 54 of the image device 70 is the same as that of the image device 40 shown in FIG. 4. In the image device 70, the ratio of the number of RGBW pixels to the number of RGBY pixels is about 3:1.

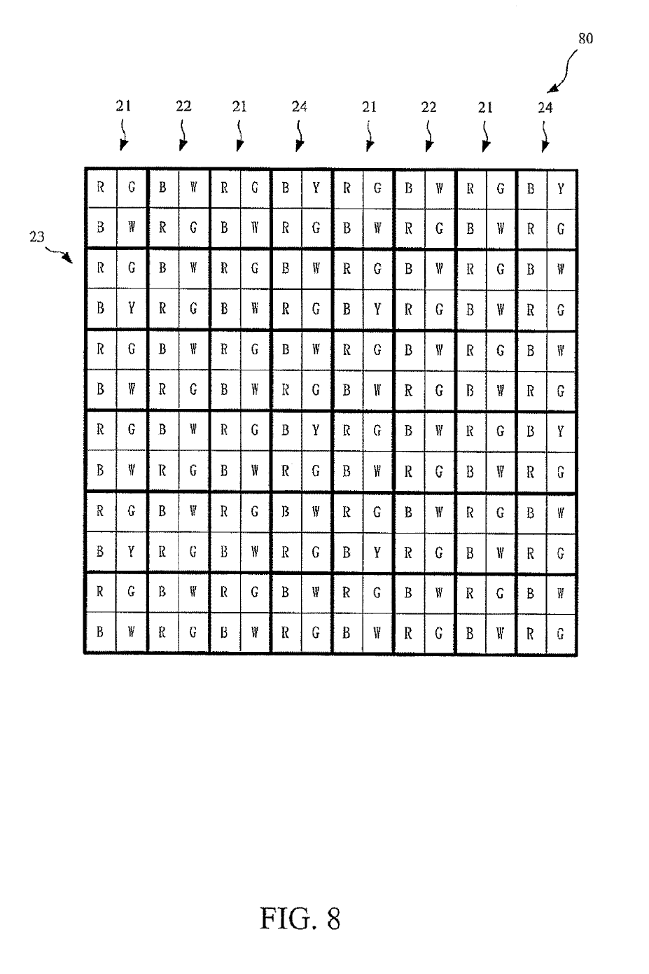

Referring to FIG. 8, it shows an image device according to an embodiment of the invention. The image device 80 includes a plurality of RGBW pixels 21, 22, and a plurality of RGBY pixels 23, 24. The arrangement in the RGBW pixels 21, 22 and the RGBY pixel 23, 24 of the image device 80 is the same as that of the image device 20A shown in FIG. 2A. In the image device 80, the ratio of the number of RGBW pixels to the number of RGBY pixels is about 5:1.

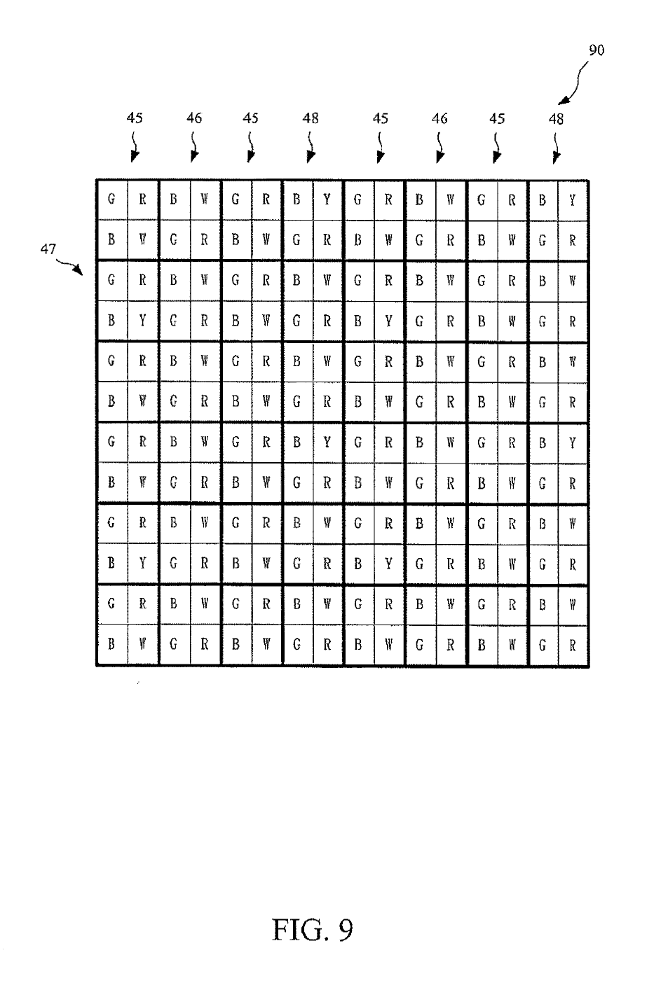

Referring to FIG. 9, it shows an image device according to an embodiment of the invention. The image device 90 includes a plurality of RGBW pixels 45, 46, and a plurality of RGBY pixels 47, 48. The arrangement in the RGBW pixels 45, 46 and the RGBY pixel 47, 48 of the image device 90 is the same as that of the image device 30 shown in FIG. 3. In the image device 90, the ratio of the number of RGBW pixels to the number of RGBY pixels is about 5:1.

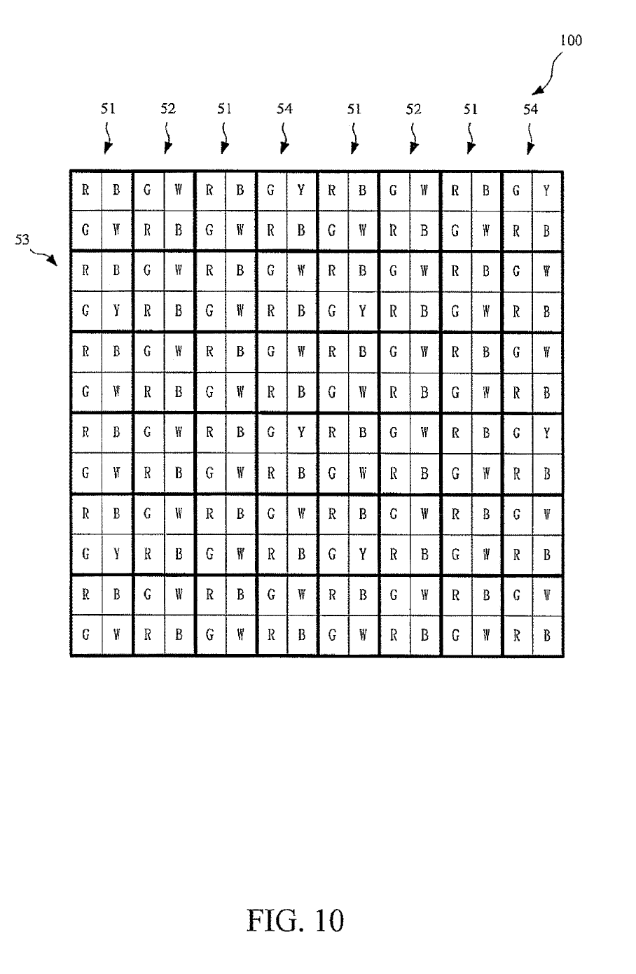

Referring to FIG. 10, it shows an image device according to an embodiment of the invention. The image device 100 includes a plurality of RGBW pixels 51, 52, and a plurality of RGBY pixels 53, 54. The arrangement in the RGBW pixels 51, 52 and the RGBY pixel 53, 54 of the image device 100 is the same as that of the image device 40 shown in FIG. 4. In the image device 100, the ratio of the number of RGBW pixels to the number of RGBY pixels is about 5:1.

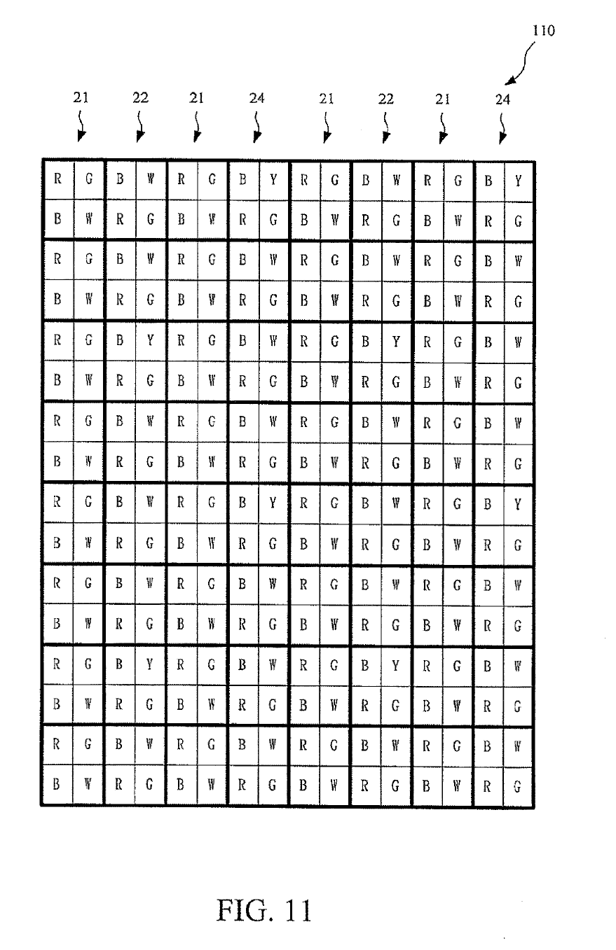

Referring to FIG. 11, it shows an image device according to an embodiment of the invention. The image device 110 includes a plurality of RGBW pixels 21, 22, and a plurality of RGBY pixels 24. The arrangement in the RGBW pixels 21, 22 and the RGBY pixel 24 of the image device 110 is the same as that of the image device 20A shown in FIG. 2A. In the image device 110, the ratio of the number of RGBW pixels to the number of RGBY pixels is about 7:1.

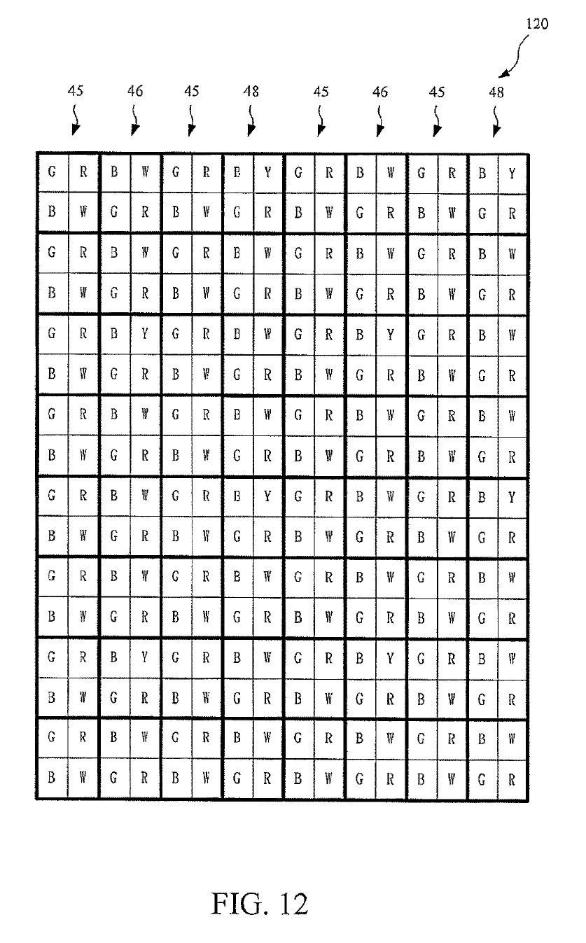

Referring to FIG. 12, it shows an image device according to an embodiment of the invention. The image device 120 includes a plurality of RGBW pixels 45, 46, and a plurality of RGBY pixels 48. The arrangement in the RGBW pixels 45, 46 and the RGBY pixel 48 of the image device 120 is the same as that of the image device 30 shown in FIG. 3. In the image device 120, the ratio of the number of RGBW pixels to the number of RGBY pixels is about 7:1.

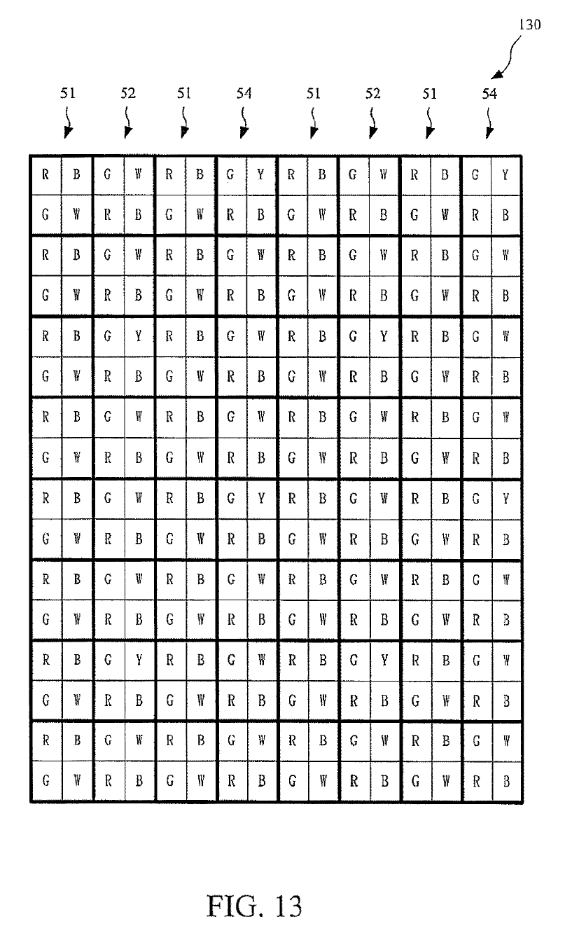

Referring to FIG. 13, it shows an image device according to an embodiment of the invention. The image device 130 includes a plurality of RGBW pixels 51, 52, and a plurality of RGBY pixels 54. The arrangement in the RGBW pixels 51, 52 and the RGBY pixel 54 of the image device 130 is the same as that of the image device 40 shown in FIG. 4. In the image device 130, the ratio of the number of RGBW pixels to the number of RGBY pixels is about 7:1.

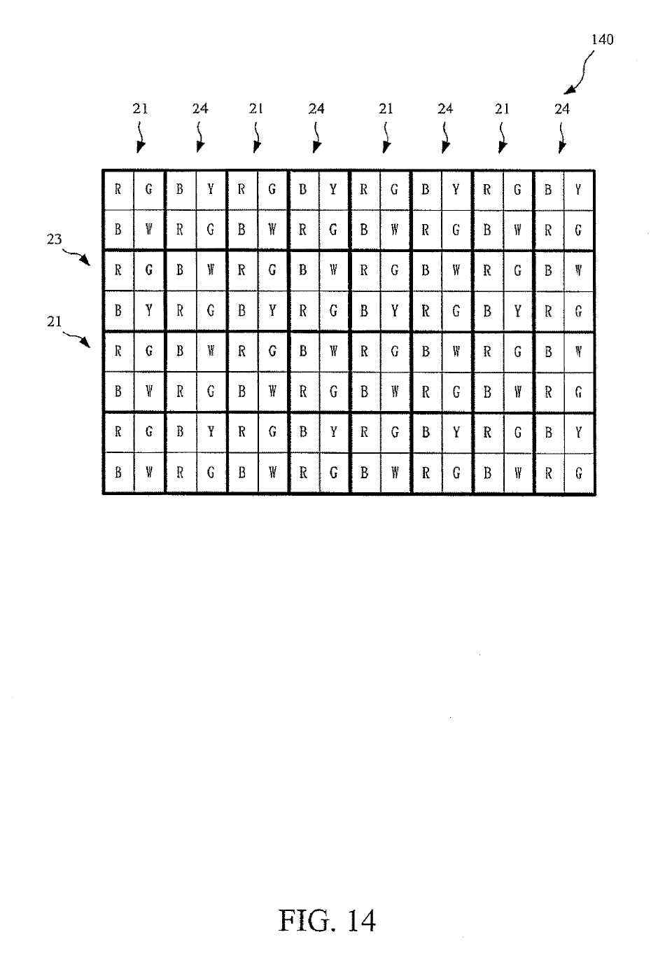

Referring to FIG. 14, it shows an image device according to an embodiment of the invention. The image device 140 includes a plurality of RGBW pixels 21, 22, and a plurality of RGBY pixels 23, 24. The arrangement in the RGBW pixels 21, 22 and the RGBY pixel 23, 24 of the image device 140 is the same as that of the image device 20A shown in FIG. 2A. In the image device 140, the ratio of the number of RGBW pixels to the number of RGBY pixels is about 2:1.

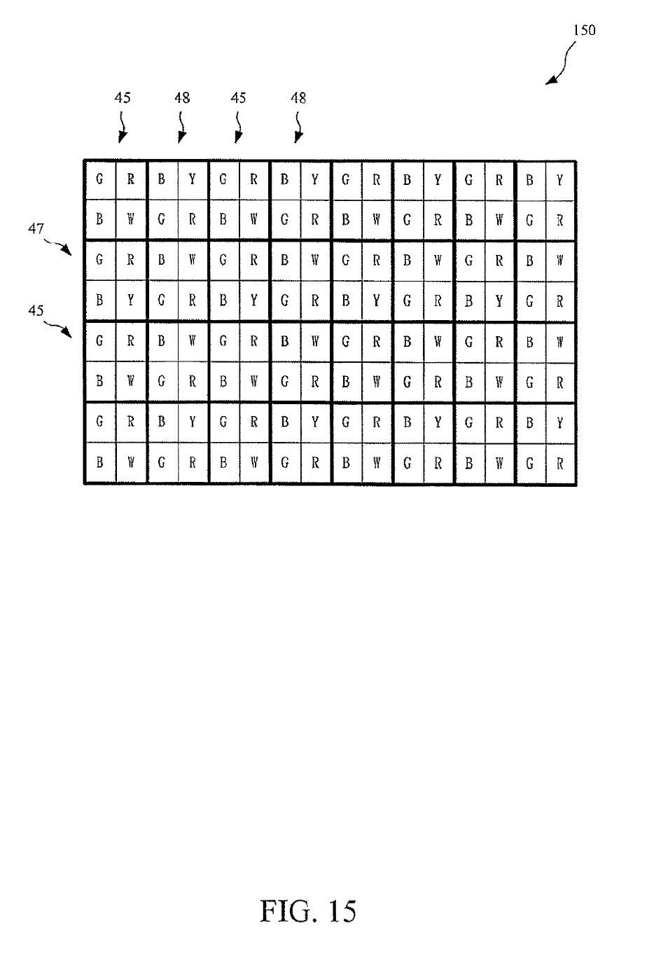

Referring to FIG. 15, it shows an image device according to an embodiment of the invention. The image device 150 includes a plurality of RGBW pixels 45, 46, and a plurality of RGBY pixels 47, 48. The arrangement in the RGBW pixels 45, 46 and the RGBY pixel 47, 48 of the image device 150 is the same as that of the image device 30 shown in FIG. 3. In the image device 150, the ratio of the number of RGBW pixels to the number of RGBY pixels is about 2:1.

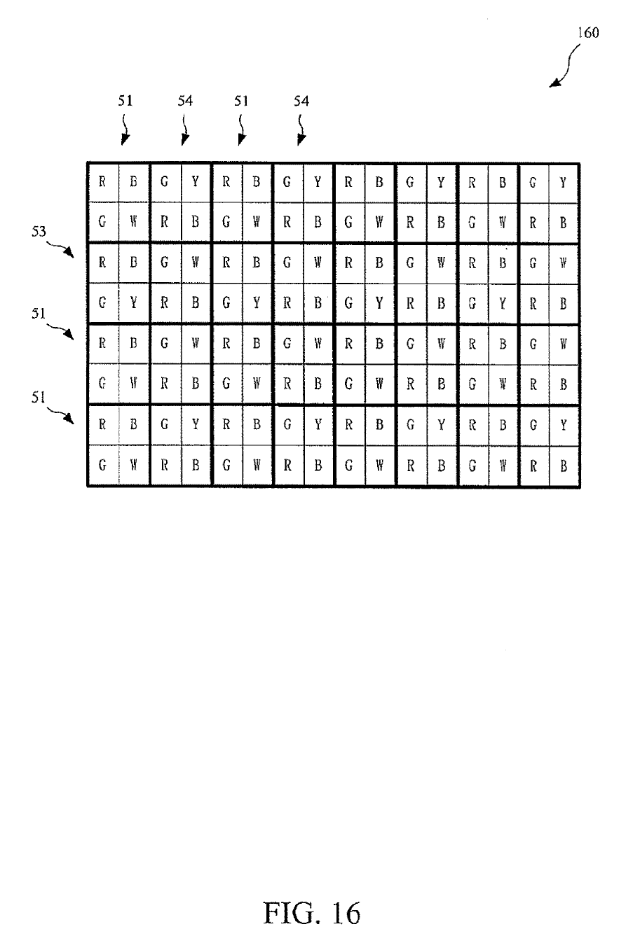

Referring to FIG. 16, it shows an image device according to an embodiment of the invention. The image device 160 includes a plurality of RGBW pixels 51, 52, and a plurality of RGBY pixels 53, 54. The arrangement in the RGBW pixels 51, 52 and the RGBY pixel 53, 54 of the image device 160 is the same as that of the image device 40 shown in FIG. 4. In the image device 160, the ratio of the number of RGBW pixels to the number of RGBY pixels is about 2:1.

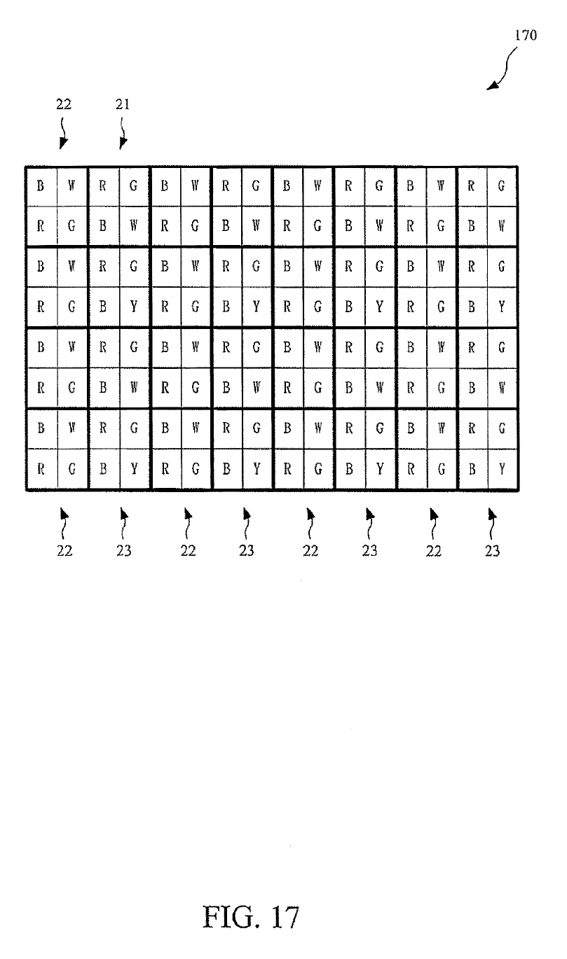

Referring to FIG. 17, it shows an image device according to an embodiment of the invention. The image device 170 includes a plurality of RGBW pixels 21, 22, and a plurality of RGBY pixels 23, 24. The arrangement in the RGBW pixels 21, 22 and the RGBY pixel 23, 24 of the image device 170 is the same as that of the image device 20A shown in FIG. 2A. In the image device 170, the ratio of the number of RGBW pixels to the number of RGBY pixels is about 3:1.

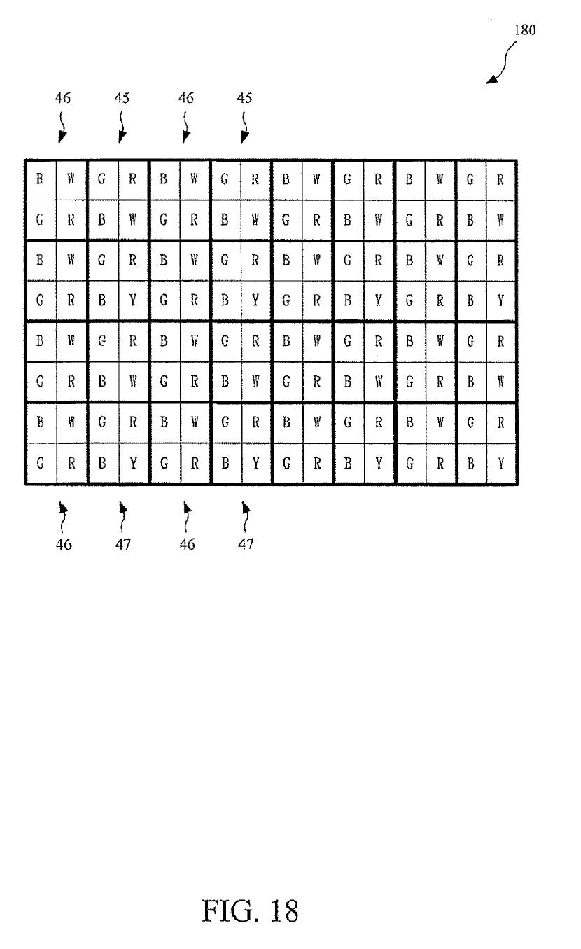

Referring to FIG. 18, it shows an image device according to an embodiment of the invention. The image device 180 includes a plurality of RGBW pixels 45, 46, and a plurality of RGBY pixels 47, 48. The arrangement in the RGBW pixels 45, 46 and the RGBY pixel 47, 48 of the image device 180 is the same as that of the image device 30 shown in FIG. 3. In the image device 180, the ratio of the number of RGBW pixels to the number of RGBY pixels is about 3:1.

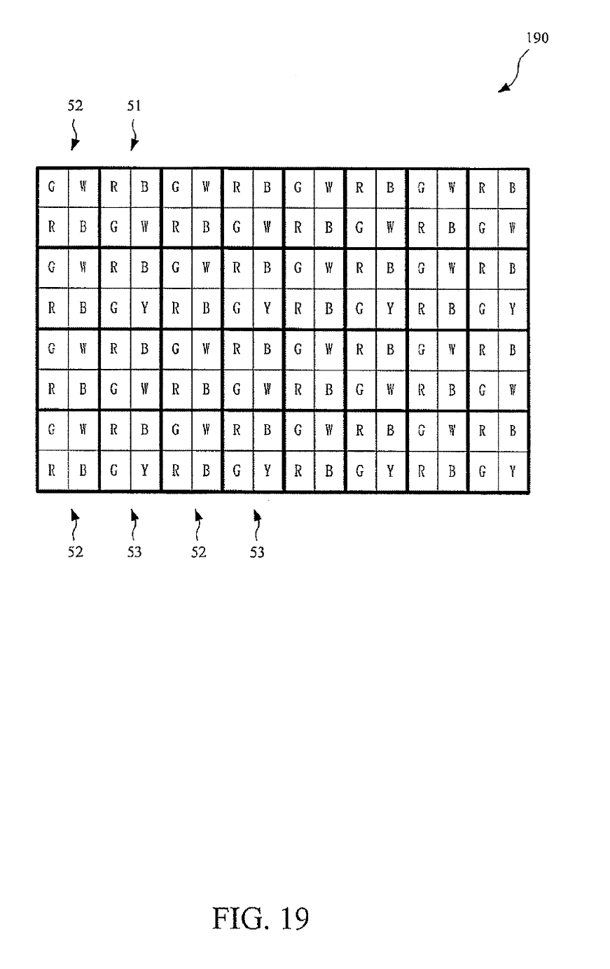

Referring to FIG. 19, it shows an image device according to an embodiment of the invention. The image device 190 includes a plurality of RGBW pixels 51, 52, and a plurality of RGBY pixels 53, 54. The arrangement in the RGBW pixels 51, 52 and the RGBY pixel 53, 54 of the image device 190 is the same as that of the image device 40 shown in FIG. 4. In the image device 190, the ratio of the number of RGBW pixels to the number of RGBY pixels is about 3:1.

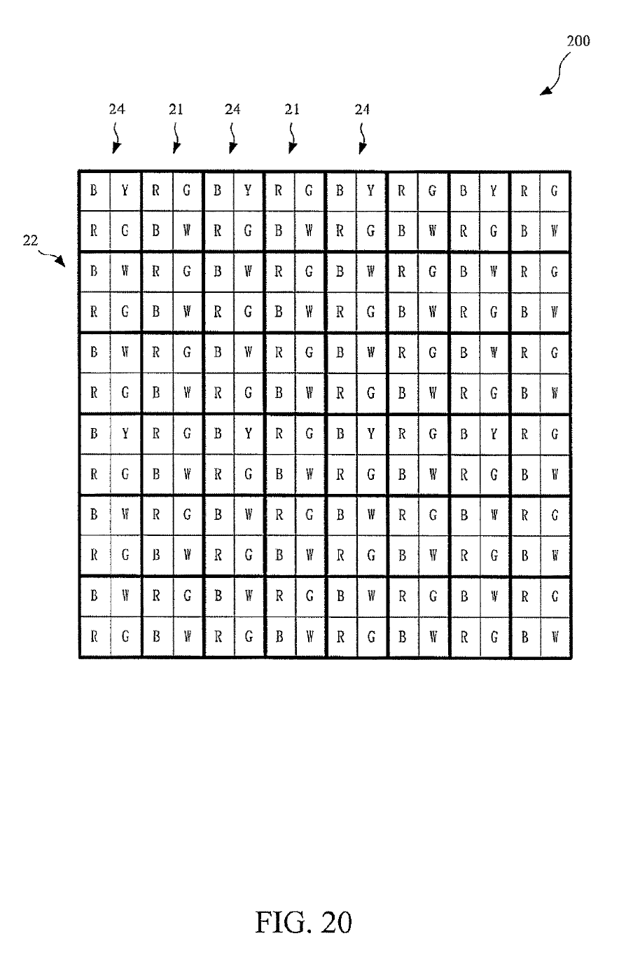

Referring to FIG. 20, it shows an image device according to an embodiment of the invention. The image device 200 includes a plurality of RGBW pixels 21, 22, and a plurality of RGBY pixels 23, 24. The arrangement in the RGBW pixels 21, 22 and the RGBY pixel 23, 24 of the image device 200 is the same as that of the image device 20A shown in FIG. 2A. In the image device 200, the ratio of the number of RGBW pixels to the number of RGBY pixels is about 5:1.

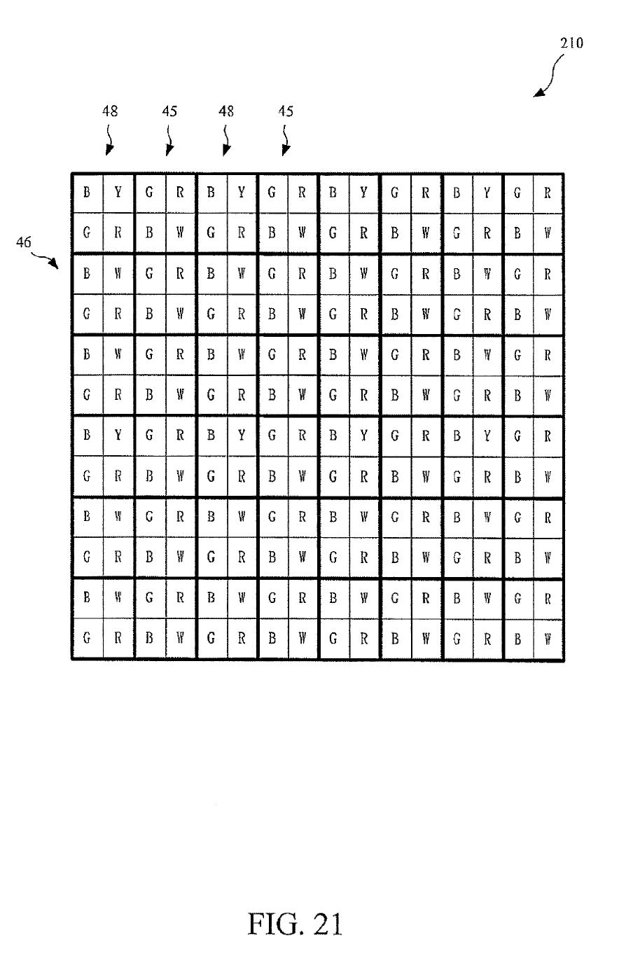

Referring to FIG. 21, it shows an image device according to an embodiment of the invention. The image device 210 includes a plurality of RGBW pixels 45, 46, and a plurality of RGBY pixels 47, 48. The arrangement in the RGBW pixels 45, 46 and the RGBY pixel 47, 48 of the image device 210 is the same as that of the image device 30 shown in FIG. 3. In the image device 210, the ratio of the number of RGBW pixels to the number of RGBY pixels is about 5:1.

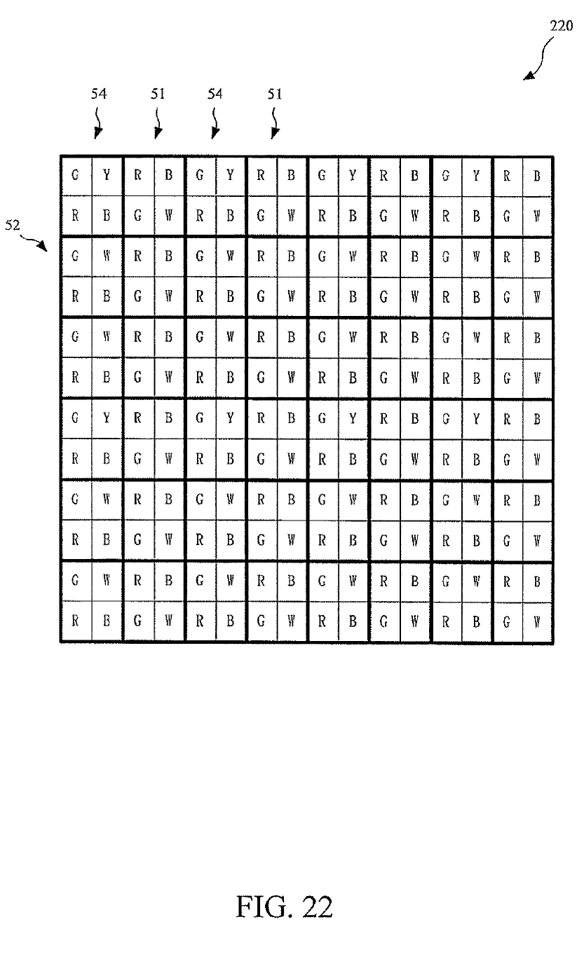

Referring to FIG. 22, it shows an image device according to an embodiment of the invention. The image device 220 includes a plurality of RGBW pixels 51, 52, and a plurality of RGBY pixels 53, 54. The arrangement in the RGBW pixels 51, 52 and the RGBY pixel 53, 54 of the image device 220 is the same as that of the image device 40 shown in FIG. 4. In the image device 220, the ratio of the number of RGBW pixels to the number of RGBY pixels is about 5:1.

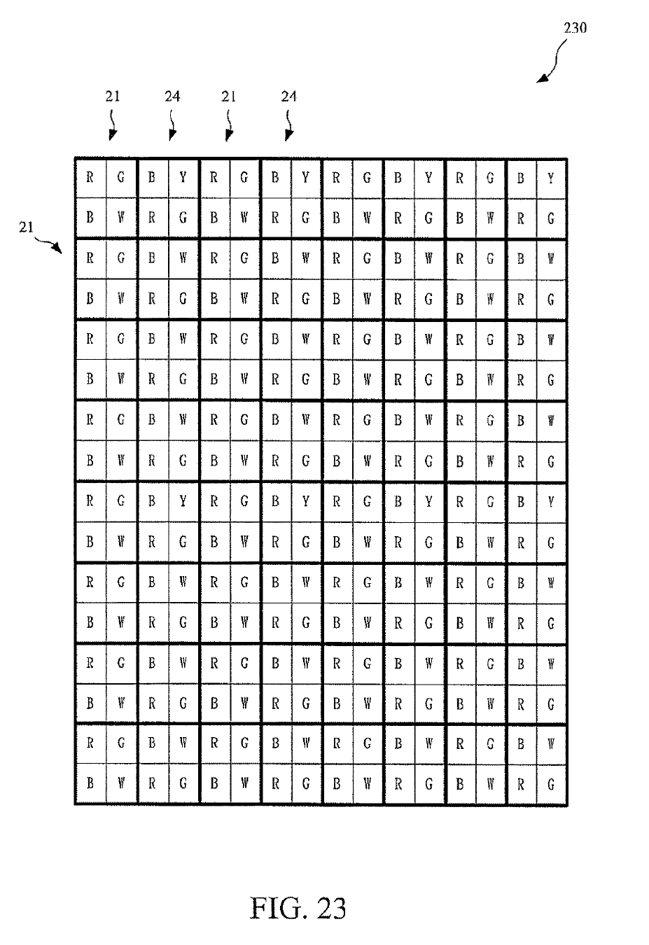

Referring to FIG. 23, it shows an image device according to an embodiment of the invention. The image device 230 includes a plurality of RGBW pixels 21, 22, and a plurality of RGBY pixels 23, 24. The arrangement in the RGBW pixels 21, 22 and the RGBY pixel 23, 24 of the image device 230 is the same as that of the image device 20A shown in FIG. 2A. In the image device 230, the ratio of the number of RGBW pixels to the number of RGBY pixels is about 7:1.

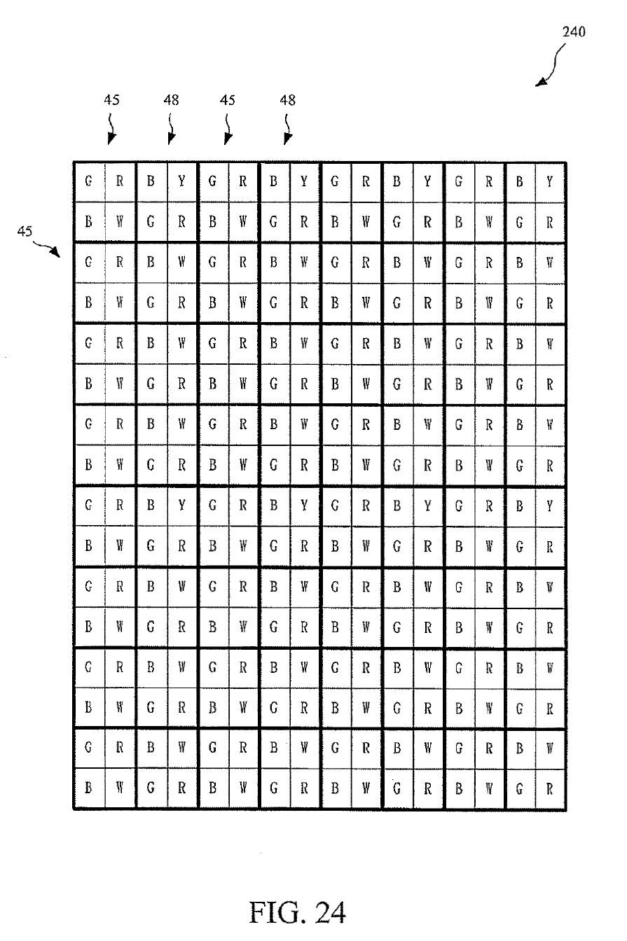

Referring to FIG. 24, it shows an image device according to an embodiment of the invention. The image device 240 includes a plurality of RGBW pixels 45, 46, and a plurality of RGBY pixels 47, 48. The arrangement in the RGBW pixels 45, 46 and the RGBY pixel 47, 48 of the image device 240 is the same as that of the image device 30 shown in FIG. 3. In the image device 240, the ratio of the number of RGBW pixels to the number of RGBY pixels is about 7:1.

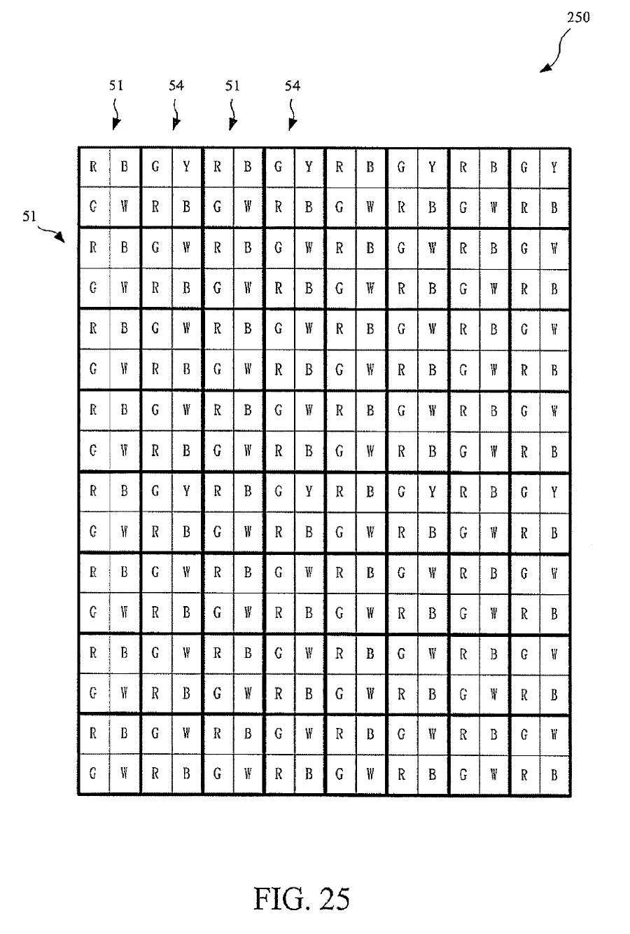

Referring to FIG. 25, it shows an image device according to an embodiment of the invention. The image device 250 includes a plurality of RGBW pixels 51, 52, and a plurality of RGBY pixels 53, 54. The arrangement in the RGBW pixels 51, 52 and the RGBY pixel 53, 54 of the image device 250 is the same as that of the image device 40 shown in FIG. 4. In the image device 250, the ratio of the number of RGBW pixels to the number of RGBY pixels is about 7:1.

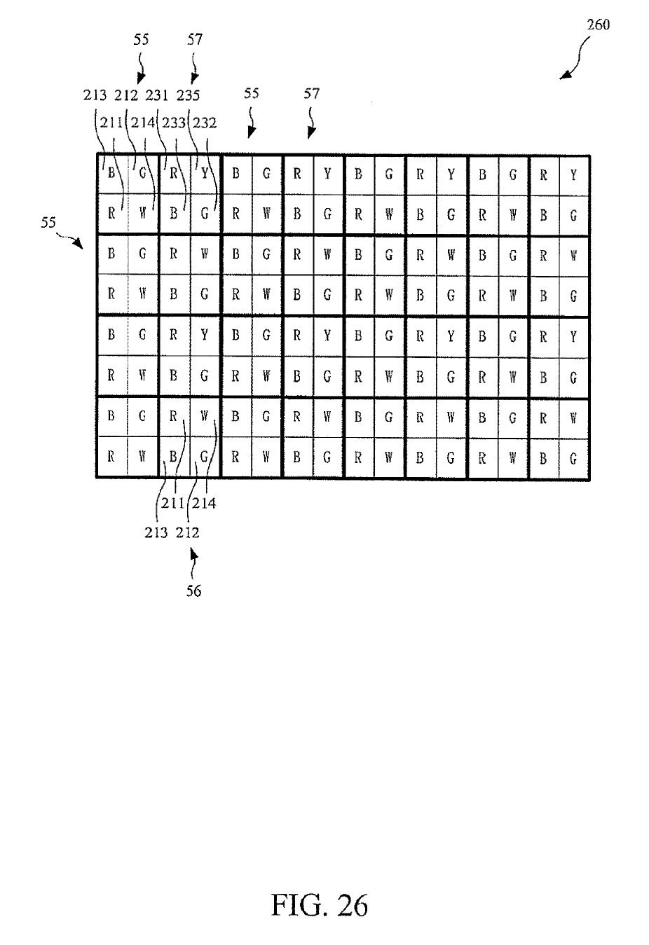

Referring to FIG. 26, it shows an image device according to an embodiment of the invention. The image device 260 includes a plurality of RGBW pixels 55, 56, and a plurality of RGBY pixels 57. The RGBW pixel 56 includes a red sub-pixel 211, a green sub-pixel 212, a blue sub-pixel 213 and a white sub-pixel 214, and the RGBW pixel 56 includes a red sub-pixel 211, a green sub-pixel 212, a blue sub-pixel 213 and a white sub-pixel 214. In an embodiment, the red sub-pixel 211, the green sub-pixel 212, the blue sub-pixel 213 and the white sub-pixel 214 are arranged in a 2×2 matrix.

In the RGBW pixel 55, the blue sub-pixel 213 is disposed on a first column and first row position of the RGBW pixel 55, the green sub-pixel 212 is disposed on a second column and first row position of the RGBW pixel 55, the red sub-pixel 211 is disposed on a first column and second row position of the RGBW pixel 55, and the white sub-pixel 214 is disposed on a second column and second row position of the RGBW pixel 55. In the RGBW pixel 56, the red sub-pixel 211 is disposed on a first column and first row position of the RGBW pixel 56, the white sub-pixel 214 is disposed on a second column and first row position of the RGBW pixel 56, the blue sub-pixel 213 is disposed on a first column and second row position of the RGBW pixel 56, and the green sub-pixel 212 is disposed on a second column and second row position of the RGBW pixel 56.

The RGBY pixel 57 includes a red sub-pixel 231, a green sub-pixel 232, a blue sub-pixel 233 and a yellow sub-pixel 235. In an embodiment, the red sub-pixel 231, the green sub-pixel 232, the blue sub-pixel 233 and the yellow sub-pixel 235 are arranged in a 2×2 matrix. In the RGBY pixel 57, the red sub-pixel 231 is disposed on a first column and first row position of the RGBY pixel 57, the yellow sub-pixel 235 is disposed on a second column and first row position of the RGBY pixel 57, the blue sub-pixel 233 is disposed on a first column and second row position of the RGBY pixel 57, and the green sub-pixel 232 is disposed on a second column and second row position of the RGBY pixel 57. In the image device 260, the ratio of the number of RGBW pixels to the number of RGBY pixels is about 3:1.

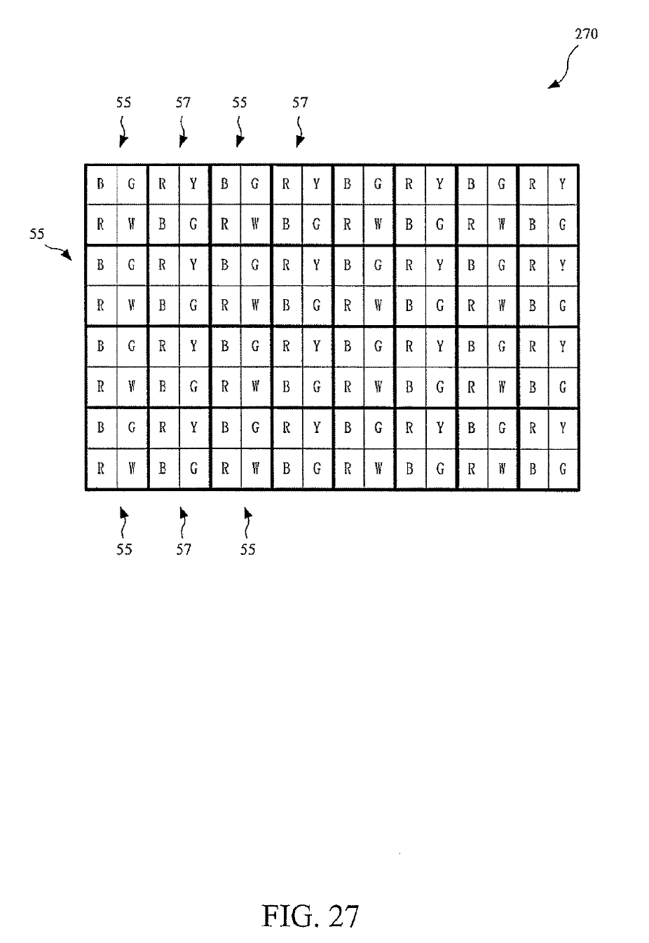

Referring to FIG. 27, it shows an image device according to an embodiment of the invention. The image device 270 includes a plurality of RGBW pixels 55, and a plurality of RGBY pixels 57. The arrangement in the RGBW pixels 55 and the RGBY pixel 57 of the image device 270 is the same as that of the image device 260 shown in FIG. 26. In the image device 270, the ratio of the number of RGBW pixels to the number of RGBY pixels is about 1:1.

Therefore, the ratio of the number of RGBW pixels to the number of RGBY pixels may be about 1:1, 2:1, 3:1, 3:2, 4:1, 4:3, 5:1, 5:2, 5:3, 5:4, 6:1, 6:5, 7:1, 7:2, 7:3, 7:4, 7:5, 7:6, 8:1, 8:3, 8:5, 8:7, 9:1, 9:2, 9:4, 9:5, 9:7 or 9:8.

Further, a designated white balance status can be maintained by adjusting the blue information of the image device. In case of liquid-crystal display LCD, for example the backlight color can be adjusted, and/or the thickness, area, and/or pigment of the blue sub-pixels in the color filter can be adjusted, and/or the utilization of quantum dots can be adjusted so as to adjust the blue information and to maintain a designated white balance status of the image device. In case of organic light-emitting diode OLED plus color filter, OLED color can be adjusted to bluish, and/or the thickness, area, and/or pigment of the blue sub-pixels in the color filter can be adjusted, and/or the utilization of quantum dots can be adjusted so as to adjust the blue information and to maintain a designated white balance status of the image device. The invention provides a method to determine the ratio of the number of RGBW pixels to the number of RGBY pixels in an image device according to the invention. The method of the invention includes a step for determining the ratio by a function of a yellow sub-pixel information, a red sub-pixel information, a green sub-pixel information, a blue sub-pixel information and a white sub-pixel information of the image device. The sub-pixel information includes the chrominance data and luminance data of the said sub-pixel. In an embodiment, the yellow sub-pixel information includes the chrominance data and luminance data of the yellow sub-pixel, the red sub-pixel information includes the chrominance data and luminance data of the red sub-pixel, the green sub-pixel information includes the chrominance data and luminance data of the green sub-pixel, and the white sub-pixel information includes the chrominance data and luminance data of the white sub-pixel.

The invention further provides a method to determine the ratio of the number of RGBW pixels to the number of RGBY pixels in an image device according to the invention. The method of the invention includes a step for determining the ratio by a function of a yellow sub-pixel information and a white sub-pixel information of the image device. The sub-pixel information includes the chrominance data and luminance data of the said sub-pixel. In an embodiment, the yellow sub-pixel information includes the chrominance data and luminance data of the yellow sub-pixel, and the white sub-pixel information includes the chrominance data and luminance data of the white sub-pixel.

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. An image device, comprising:
a plurality of RGBW pixels, each RGBW pixel comprising a red sub-pixel, a green sub-pixel, a blue sub-pixel and a white sub-pixel; and
a plurality of RGBY pixels, each RGBY pixel comprising a red sub-pixel, a green sub-pixel, a blue sub-pixel and a yellow sub-pixel, wherein four sub-pixels arranged in a 2×2 matrix are formed the RGBW pixel or the RGBY pixel, the RGBW pixels and the RGBY pixels are mixed in the image device.

2. The image device according to claim 1, further comprising at least one block, wherein the block comprises nine sub-pixels arranged in a 3×3 matrix, a white sub-pixel or a yellow sub-pixel is disposed in a center of the 3×3 matrix, and the other sub-pixels comprise two red sub-pixels, three green sub-pixels and three blue sub-pixels; or two green sub-pixels, three red sub-pixels and three blue sub-pixels; or two blue sub-pixels, three green sub-pixels and three red sub-pixels.

3. The image device according to claim 1, wherein the number of RGBW pixels is greater than or equal to the number of RGBY pixels.

4. The image device according to claim 3, wherein the ratio of the number of RGBW pixels to the number of RGBY pixels is about 1:1.

5. The image device according to claim 3, wherein the ratio of the number of RGBW pixels to the number of RGBY pixels is about 2:1.

6. The image device according to claim 3, wherein the ratio of the number of RGBW pixels to the number of RGBY pixels is about 3:1.

7. The image device according to claim 3, wherein the ratio of the number of RGBW pixels to the number of RGBY pixels is about 3:2.

8. The image device according to claim 3, wherein the ratio of the number of RGBW pixels to the number of RGBY pixels is about 4:1.

9. The image device according to claim 3, wherein the ratio of the number of RGBW pixels to the number of RGBY pixels is about 4:3.

10. The image device according to claim 3, wherein the ratio of the number of RGBW pixels to the number of RGBY pixels is about 5:1.

11. The image device according to claim 3, wherein the ratio of the number of RGBW pixels to the number of RGBY pixels is about 5:2.

12. The image device according to claim 3, wherein the ratio of the number of RGBW pixels to the number of RGBY pixels is about 5:3.

13. The image device according to claim 3, wherein the ratio of the number of RGBW pixels to the number of RGBY pixels is about 5:4.

14. The image device according to claim 3, wherein the ratio of the number of RGBW pixels to the number of RGBY pixels is about 6:1.

15. The image device according to claim 3, wherein the ratio of the number of RGBW pixels to the number of RGBY pixels is about 6:5.

16. The image device according to claim 3, wherein the ratio of the number of RGBW pixels to the number of RGBY pixels is about 7:1.

17. The image device according to claim 3, wherein the ratio of the number of RGBW pixels to the number of RGBY pixels is about 7:2.

18. The image device according to claim 3, wherein the ratio of the number of RGBW pixels to the number of RGBY pixels is about 7:3.

19. The image device according to claim 3, wherein the ratio of the number of RGBW pixels to the number of RGBY pixels is about 7:4.

20. The image device according to claim 3, wherein the ratio of the number of RGBW pixels to the number of RGBY pixels is about 7:5.

21. The image device according to claim 3, wherein the ratio of the number of RGBW pixels to the number of RGBY pixels is about 7:6.

22. The image device according to claim 3, wherein the ratio of the number of RGBW pixels to the number of RGBY pixels is about 8:1.

23. The image device according to claim 3, wherein the ratio of the number of RGBW pixels to the number of RGBY pixels is about 8:3.

24. The image device according to claim 3, wherein the ratio of the number of RGBW pixels to the number of RGBY pixels is about 8:5.

25. The image device according to claim 3, wherein the ratio of the number of RGBW pixels to the number of RGBY pixels is about 8:7.

26. The image device according to claim 3, wherein the ratio of the number of RGBW pixels to the number of RGBY pixels is about 9:1.

27. The image device according to claim 3, wherein the ratio of the number of RGBW pixels to the number of RGBY pixels is about 9:2.

28. The image device according to claim 3, wherein the ratio of the number of RGBW pixels to the number of RGBY pixels is about 9:4.

29. The image device according to claim 3, wherein the ratio of the number of RGBW pixels to the number of RGBY pixels is about 9:5.

30. The image device according to claim 3, wherein the ratio of the number of RGBW pixels to the number of RGBY pixels is about 9:7.

31. The image device according to claim 3, wherein the ratio of the number of RGBW pixels to the number of RGBY pixels is about 9:8.

32. The image device according to claim 1, wherein each sub-pixel is formed as about a rectangular shape.

33. The image device according to claim 32, wherein any two adjacent sub-pixels along a longer border are formed as about a square shape.

34. The image device according to claim 32, wherein any three adjacent sub-pixels along a longer border are formed as about a square shape.

35. The image device according to claim 32, wherein any four adjacent sub-pixels along a longer border are formed as about a square shape.

36. The image device according to claim 1, wherein each sub-pixel is formed as about a square shape.

37. The image device according to claim 1, wherein four sub-pixels arranged in one row are formed the RGBW pixel or the RGBY pixel, or four sub-pixels arranged in one column are formed the RGBW pixel or the RGBY pixel.

38. The image device according to claim 1, wherein a designated white balance status is maintained.

39. The image device according to claim 38, wherein the designated white balance status of the image device is maintained by adjusting the blue information of the image device.

40. The image device according to claim 39, wherein the image device is a LCD image device.

41. The image device according to claim 40, wherein the blue information of the image device is adjusted by adjusting the backlight color, and/or adjusting the thickness, area, and/or pigment of the blue sub-pixels in the color filter, and/or the utilization of quantum dots.

42. The image device according to claim 39, wherein the image device is an OLED plus color filter image device.

43. The image device according to claim 42, wherein the blue information of the image device is adjusted by adjusting OLED color to bluish, and/or the thickness, area, and/or pigment of the blue sub-pixels in the color filter, and/or the utilization of quantum dots.

44. A method to determine the ratio of the number of RGBW pixels to the number of RGBY pixels in an image device according to claim 1, the method comprising a step for determining the ratio by a function of a yellow sub-pixel information, a red sub-pixel information, a green sub-pixel information, a blue sub-pixel information and a white sub-pixel information of the image device.

45. The method according to claim 44, wherein the sub-pixel information comprises the chrominance and luminance data of the said sub-pixel.

46. A method to determine the ratio of the number of RGBW pixels to the number of RGBY pixels in an image device according to claim 1, the method comprising a step for determining the ratio by a function of a yellow sub-pixel information and a white sub-pixel information of the image device.

47. The method according to claim 46, wherein the sub-pixel information comprises the chrominance data and luminance data of the said sub-pixel.
